(19) United States
(12) Patent Application Publication
(10) Pub. No.: US 2011/0190972 A1
(43) Pub. Date: Aug. 4, 2011

(54) GRID UNLOCK

(75) Inventors: Adam T. Timmons, Southfield, MI (US); Osman D. Altan, Bloomfield Hills, MI (US)

(73) Assignee: GM GLOBAL TECHNOLOGY OPERATIONS, INC., Detroit, MI (US)

(21) Appl. No.: 12/698,321

(22) Filed: Feb. 2, 2010

(51) Int. Cl. G08G 1/16; G01S 19/42; G01C 21/34

(52) U.S. Cl. 701/29; 342/357.25

(57) ABSTRACT

A method to operate a vehicle during a grid-lock traffic condition includes monitoring a vehicle speed, tracking a target vehicle in proximity of the vehicle including monitoring a range to the target vehicle, monitoring activation of a grid unlock mode when the vehicle speed is less than a threshold grid-lock speed, monitoring a location of the vehicle based upon data from a GPS device, monitoring a distance envelope with respect to the vehicle, and controlling operation of the vehicle while the vehicle speed remains less than the threshold grid-lock speed based upon the vehicle speed, the range to the target vehicle, the location of the vehicle, and the distance envelope. Controlling operation of the vehicle includes controlling acceleration of the vehicle, controlling braking of the vehicle, and controlling steering of the vehicle.

### TECHNICAL FIELD

The present disclosure relates generally to systems for detecting the presence of stationary and non-stationary objects in the vicinity of a traveling vehicle, and controlling vehicle operational parameters in response to the presence of such objects.

### BACKGROUND

The statements in this section merely provide background information related to the present disclosure and may not constitute prior art.

Motorized vehicles including automobiles, trucks and the like require an operator to control their direction and rate of travel. This is typically accomplished by a steering wheel, a brake pedal and an accelerator pedal. Grid-locked traffic occurs on highways in urban areas during peak travel times, a.k.a. rush hour, during which vehicle densities on roadways are high and vehicle travel rates are low. In grid-locked traffic the typical vehicle operator is required to repeatedly apply braking and acceleration in response to the motions of the vehicles in front of them, requiring constant attention to avoid collision situations.

### SUMMARY

A method to operate a vehicle during a grid-lock traffic condition includes monitoring a vehicle speed, tracking a target vehicle in proximity of the vehicle including monitoring a range to the target vehicle, monitoring activation of a grid unlock mode when the vehicle speed is less than a threshold grid-lock speed, monitoring a location of the vehicle based upon data from a GPS device, monitoring a distance envelope with respect to the vehicle, and controlling operation of the vehicle while the vehicle speed remains less than the threshold grid-lock speed based upon the vehicle speed, the range to the target vehicle, the location of the vehicle, and the distance envelope. Controlling operation of the vehicle includes controlling acceleration of the vehicle, controlling braking of the vehicle, and controlling steering of the vehicle.

### BRIEF DESCRIPTION OF THE DRAWINGS

One or more embodiments will now be described, by way of example, with reference to the accompanying drawings, in which:

FIG. 1 schematically depicts an exemplary vehicle utilizing sensors to create a fused track of an object, in accordance with the present disclosure;

FIG. 2 schematically depicts an exemplary process to monitor sensor inputs and create a track list, in accordance with the present disclosure;

FIG. 3 schematically illustrates an exemplary system whereby sensor inputs are fused into object tracks useful in a collision preparation system, in accordance with the present disclosure;

FIG. 4 schematically illustrates an exemplary fusion module, in accordance with the present disclosure;

FIG. 5 schematically depicts an exemplary bank of Kalman filters operating to estimate position and velocity of a group objects, in accordance with the present disclosure;

FIG. 6 illustrates exemplary range data overlaid onto a corresponding image plane, in accordance with the present disclosure;

FIGS. 7 and 8 are schematic depictions of a vehicle system, in accordance with the present disclosure;

FIGS. 9 and 10 are schematic depictions of operation of an exemplary vehicle, in accordance with the present disclosure;

FIGS. 11, 12 and 13 are algorithmic flowcharts, in accordance with the present disclosure;

FIGS. 14 and 15 are schematic diagrams, in accordance with the present disclosure;

FIG. 16 depicts an exemplary target vehicle following control system, in accordance with the present disclosure;

FIG. 17 graphically depicts an exemplary speed profile, in accordance with the present disclosure;

FIG. 18 graphically illustrates an exemplary speed profile and an exemplary smooth operational speed profile, in accordance with the present disclosure;

FIG. 19 depicts a exemplary process whereby the control region in which a vehicle is operating can be determined, in accordance with the present disclosure;

FIG. 20 depicts an exemplary information flow wherein a reference acceleration and a reference speed may be determined, in accordance with the present disclosure;

FIG. 21 schematically depicts operation of the above methods combined into a configuration performing the various methods, in accordance with the present disclosure;

FIG. 22 graphically depicts a speed-range trajectory of a host vehicle relative to that of a target vehicle, in accordance with the present disclosure;

FIG. 23 graphically depicts tracking speed of a host vehicle and a target vehicle as a function of time against a reference, in accordance with the present disclosure;

FIG. 24 graphically depicts a target vehicle following range as a function of time against a reference, in accordance with the present disclosure;

FIG. 25 graphically depicts a target object following acceleration as a function of time, in accordance with the present disclosure;

FIG. 26 depicts an overhead perspective view of a situation in which one vehicle cuts in front of another, in accordance with the present disclosure;

FIG. 27 graphically depicts speed versus time for simulation results conducted, in accordance with the present disclosure;

FIG. 28 graphically depicts range versus time for simulation results conducted, in accordance with the present disclosure;

FIG. 29 graphically depicts acceleration versus time for simulation results conducted, in accordance with the present disclosure;

FIG. 30 graphically depicts host vehicle speed versus range for simulation results conducted, in accordance with the present disclosure;

FIG. 31 graphically depicts speed versus time for simulation results conducted, in accordance with the present disclosure;

FIG. 32 graphically depicts range versus time for simulation results conducted, in accordance with the present disclosure;

FIG. 33 graphically depicts acceleration versus time for simulation results conducted, in accordance with the present disclosure;

FIG. 34 graphically depicts host vehicle speed versus range for simulation results conducted, in accordance with the present disclosure;

FIG. 35 graphically depicts range versus time for simulation results conducted, in accordance with the present disclosure;

FIG. 36 graphically depicts acceleration versus time for simulation results conducted, in accordance with the present disclosure;

FIG. 37 graphically depicts host vehicle speed versus range for simulation results conducted, in accordance with the present disclosure;

FIG. 38 graphically depicts range versus time for simulation results conducted, in accordance with the present disclosure;

FIG. 39 graphically depicts range versus time for simulation results conducted, in accordance with the present disclosure;

FIG. 40 graphically depicts acceleration versus time for simulation results conducted, in accordance with the present disclosure;

FIG. 41 graphically depicts host vehicle speed versus range for simulation results conducted, in accordance with the present disclosure;

FIG. 42 graphically depicts range versus time for simulation results conducted, in accordance with the present disclosure;

FIG. 43 schematically illustrates an exemplary vehicle equipped with a multiple feature adaptive cruise control, in accordance with the present disclosure;

FIG. 44 schematically illustrates operation of an exemplary conventional cruise control system, in accordance with the present disclosure;

FIG. 45 schematically illustrates operation of an exemplary conventional cruise control system, in accordance with the present disclosure;

FIG. 46 schematically illustrates operation of an exemplary speed limit following control system, in accordance with the present disclosure;

FIG. 47 schematically illustrates operation of an exemplary speed limit following control system, in accordance with the present disclosure;

FIG. 48 schematically illustrates an exemplary control system, including a command arbitration function, monitoring various inputs and creating a single velocity output and a single acceleration output for use by a single vehicle speed controller, in accordance with the present disclosure;

FIG. 49 illustrates an exemplary data flow predicting future speeds required by various speed control methods and utilizing a command arbitration function to select a method based upon the arbitration, in accordance with the present disclosure;

FIG. 50 graphically illustrates exemplary reaction times of a vehicle to changes in desired speeds of various ACC features, including an exemplary prediction of desired future speed, in accordance with the present disclosure;

FIG. 51 depicts an exemplary GPS coordinate that is monitored by a GPS device, in accordance with the present disclosure;

FIG. 52 depicts information from a GPS device, including a nominal position, a GPS error margin, and a determined actual position defining a GPS offset error, in accordance with an embodiment of the present disclosure;

FIG. 53 depicts a host vehicle and two target objects, all monitoring GPS nominal positions, and resulting GPS offset errors, in accordance with embodiments of the present disclosure;

FIG. 54 depicts vehicles utilizing exemplary methods to control vehicle operation, in accordance with the present disclosure; and

FIG. 55 is a schematic of a system provided in accordance with one embodiment of the disclosure.

### DESCRIPTION OF THE PREFERRED EMBODIMENT

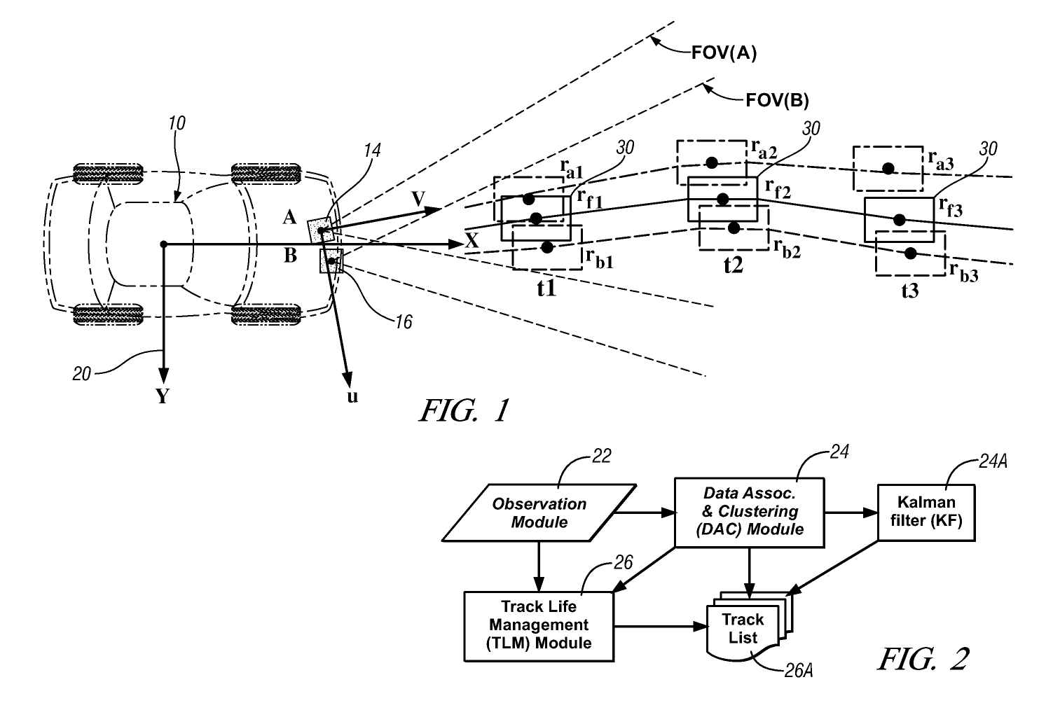

Referring now to the drawings, which are provided for the purpose of illustrating exemplary embodiments only and not for the purpose of limiting the same, FIG. 1 schematically depicts an exemplary vehicle utilizing sensors to create a fused track of an object, in accordance with the present disclosure. The exemplary vehicle includes a passenger vehicle intended for use on highways, although it is understood that the disclosure described herein is applicable on any vehicle or other system seeking to monitor position and trajectory of remote vehicles and other objects. The vehicle includes a control system containing various algorithms and calibrations executed at various times. The control system is preferably a subset of an overall vehicle control architecture provides coordinated vehicle system control. The control system monitors inputs from various sensors, synthesizes pertinent information and inputs, and executes algorithms to control various actuators to achieve control targets, including such parameters as collision avoidance and adaptive cruise control (ACC). The vehicle control architecture includes a plurality of distributed controllers and devices, including a system controller providing functionality such as antilock braking, traction control, and vehicle stability.

Each controller is preferably a general-purpose digital computer generally including a microprocessor or central processing unit, read only memory (ROM), random access memory (RAM), electrically programmable read only memory (EPROM), high speed clock, analog-to-digital (A/D) and digital-to-analog (D/A) circuitry, input/output circuitry and devices (I/O) and appropriate signal conditioning and buffer circuitry. Each processor has a set of control algorithms, including resident program instructions and calibrations stored in ROM and executed to provide respective functions.

Algorithms described herein are typically executed during preset loop cycles such that each algorithm is executed at least once each loop cycle. Algorithms stored in the non-volatile memory devices are executed and are operable to monitor inputs from the sensing devices and execute control and diagnostic routines to control operation of a respective device, using preset calibrations. Loop cycles are typically executed at regular intervals, for example each 3, 6.25, 15, 25 and 100 milliseconds during ongoing engine and vehicle operation. Alternatively, algorithms may be executed in response to occurrence of an event. These same principles may be employed to provide vehicle all-around proximity sensing.

FIG. 2 schematically depicts an exemplary process to monitor sensor inputs and create a track list, in accordance with the present disclosure. Exemplary vehicle 10 generally includes a control system having an observation module 22, a data association and clustering (DAC) module 24 that further includes a Kalman filter 24A, and a track life management (TLM) module 26 that keeps track of a track list 26A including of a plurality of object tracks. More particularly, the observation module includes sensors 14 and 16, their respective sensor processors, and the interconnection between the sensors, sensor processors, and the DAC module.

The exemplary sensing system preferably includes object-locating sensors including at least two forward-looking range sensing devices 14 and 16 and accompanying subsystems or processors. The object-locating sensors may include a short-range radar subsystem, a long-range radar subsystem, and a forward vision subsystem. The object-locating sensing devices may include any range sensors, such as FM-CW radars, (Frequency Modulated Continuous Wave), pulse and FSK (Frequency Shift Keying) radars, and LIDAR (Light Detection and Ranging) devices, and ultrasonic devices which rely upon effects such as Doppler-effect measurements to locate forward objects. The possible object-locating devices include charged-coupled devices (CCD) or complementary metal oxide semi-conductor (CMOS) video image sensors, and other known camera/video image processors which utilize digital photographic methods to ‘view’ forward objects. Such sensing systems are employed for detecting and locating objects in automotive applications, useable with systems including, e.g., adaptive cruise control, collision avoidance, pre-crash safety, and side-object detection. The exemplary vehicle system may also include a global position sensing (GPS) system.

These sensors are preferably positioned within the vehicle 10 in relatively unobstructed positions relative to a view in front of the vehicle. It is also appreciated that each of these sensors provides an estimate of actual location or condition of a targeted object, wherein said estimate includes an estimated position and standard deviation. As such, sensory detection and measurement of object locations and conditions are typically referred to as “estimates.” It is further appreciated that the characteristics of these sensors are complementary, in that some are more reliable in estimating certain parameters than others. Conventional sensors have different operating ranges and angular coverages, and are capable of estimating different parameters within their operating range. For example, radar sensors can usually estimate range, range rate and azimuth location of an object, but are not normally robust in estimating the extent of a detected object. A camera with vision processor is more robust in estimating a shape and azimuth position of the object, but is less efficient at estimating the range and range rate of the object. Scanning type LIDARS perform efficiently and accurately with respect to estimating range, and azimuth position, but typically cannot estimate range rate, and are therefore not accurate with respect to new object acquisition/recognition. Ultrasonic sensors are capable of estimating range but are generally incapable of estimating or computing range rate and azimuth position. Further, it is appreciated that the performance of each sensor technology is affected by differing environmental conditions. Thus, conventional sensors present parametric variances whose operative overlap of these sensors creates opportunities for sensory fusion.

Each object-locating sensor and subsystem provides an output including range, R, time-based change in range, R_dot, and angle, Θ, preferably with respect to a longitudinal axis of the vehicle, which can be written as a measurement vector (O), i.e., sensor data. An exemplary short-range radar subsystem has a field-of-view (FOV) of 160 degrees and a maximum range of thirty meters. An exemplary long-range radar subsystem has a field-of-view of 17 degrees and a maximum range of 220 meters. An exemplary forward vision subsystem has a field-of-view of 45 degrees and a maximum range of 50 meters. For each subsystem the field-of-view is preferably oriented around the longitudinal axis of the vehicle 10. The vehicle is preferably oriented to a coordinate system, referred to as an XY-coordinate system 20, wherein the longitudinal axis of the vehicle 10 establishes the X-axis, with a locus at a point convenient to the vehicle and to signal processing, and the Y-axis is established by an axis orthogonal to the longitudinal axis of the vehicle 10 and in a horizontal plane, which is thus parallel to ground surface.

The above exemplary object tracking system illustrates one method by which an object or multiple objects may be tracked. However, one having ordinary skill in the art will appreciate that a number of different sensors gathering information regarding the environment around the vehicle might be utilized similarly, and the disclosure is not intended to be limited to the particular embodiments described herein. Additionally, the data fusion method described above is one exemplary method by which the details of the various input sensors might be fused into a single useful track of an object. However, numerous data fusion methods are known in the art, and the disclosure is not intended to be limited to the particular exemplary embodiment described herein.

Object tracks can be utilized for a variety of purposes including adaptive cruise control, wherein the vehicle adjusts speed to maintain a minimum distance from vehicles in the current path. Another similar system wherein object tracks can be utilized is a collision preparation system (CPS), wherein identified object tracks are analyzed in order to identify a likely impending or imminent collision based upon the track motion relative to the vehicle. A CPS warns the driver of an impending collision and may reduce collision severity by automatic braking if the collision is considered to be unavoidable. A method is disclosed for utilizing a multi-object fusion module with a CPS, providing countermeasures, such as seat belt tightening, throttle idling, automatic braking, air bag preparation, adjustment to head restraints, horn and headlight activation, adjustment to pedals or the steering column, adjustments based upon an estimated relative speed of impact, adjustments to suspension control, and adjustments to stability control systems, when a collision is determined to be imminent.

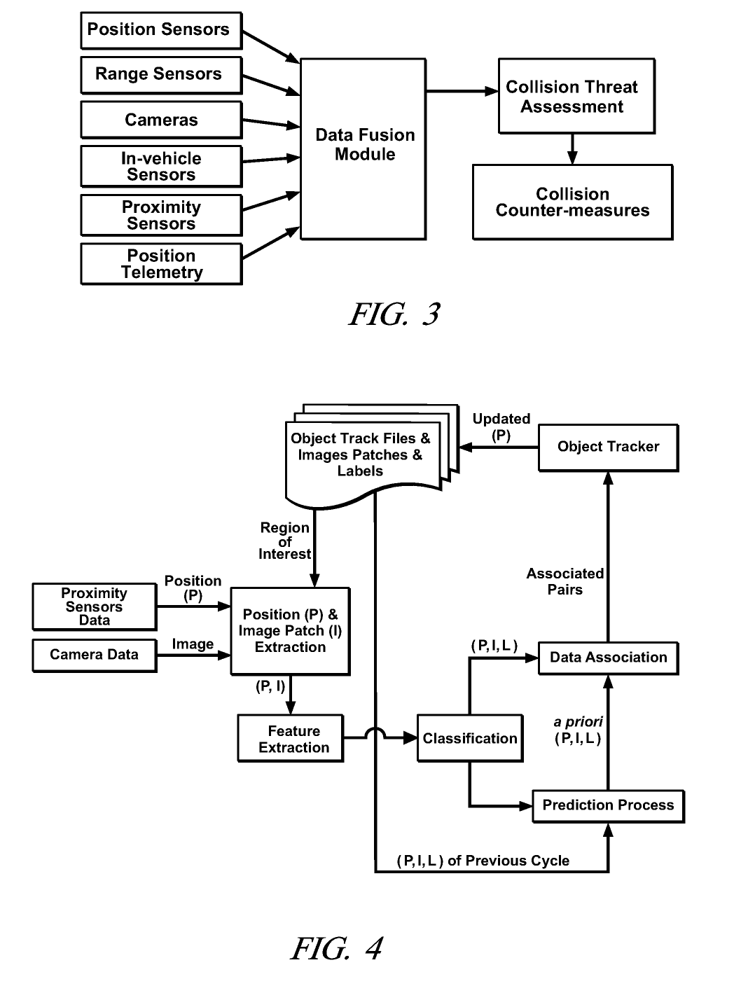

FIG. 3 schematically illustrates an exemplary system whereby all or only some of the various sensor inputs shown are fused into object tracks useful in a collision preparation system, in accordance with the present disclosure. Inputs related to objects in an environment around the vehicle are monitored by a data fusion module. The data fusion module analyzes, filters, or prioritizes the inputs relative to the reliability of the various inputs, and the prioritized or weighted inputs are summed to create track estimates for objects in front of the vehicle. These object tracks are then input to the collision threat assessment module, wherein each track is assessed for a likelihood for collision. This likelihood for collision can be evaluated, for example, against a threshold likelihood for collision, and if a collision is determined to be likely, collision counter-measures can be initiated.

As shown in FIG. 3, a CPS continuously monitors the surround environment using its range sensors (e.g., radars and LIDARS) and cameras and take appropriate counter-measurements in order to avoid incidents or undesirable situations to develop into a collision. A collision threat assessment generates output for the system actuator to respond.

As described in FIG. 3, a fusion module is useful to integrate input from various sensing devices and generate a fused track of an object in front of the vehicle. The fused track created in FIG. 3 includes a data estimate of relative location and trajectory of an object relative to the vehicle. This data estimate, based upon radar and other range finding sensor inputs is useful, but includes the inaccuracies and imprecision of the sensor devices utilized to create the track. As described above, different sensor inputs can be utilized in unison to improve accuracy of the estimates involved in the generated track. In particular, an application with invasive consequences such as automatic braking and potential airbag deployment require high accuracy in predicting an imminent collision, as false positives can have an impact upon vehicle drivability, and missed indications can result in inoperative safety systems.

Vision systems provide an alternate source of sensor input for use in vehicle control systems. Methods for analyzing visual information are known in the art to include pattern recognition, corner detection, vertical edge detection, vertical object recognition, and other methods. However, it will be appreciated that high-resolution visual representations of the field in front a vehicle refreshing at a high rate necessary to appreciate motion in real-time include a very large amount of information to be analyzed. Real-time analysis of visual information can be prohibitive. A method is disclosed to fuse input from a vision system with a fused track created by methods such as the exemplary track fusion method described above to focus vision analysis upon a portion of the visual information most likely to pose a collision threat and utilized the focused analysis to alert to a likely imminent collision event.

FIG. 4 schematically illustrates an exemplary image fusion module, in accordance with the present disclosure. The fusion module of FIG. 4 monitors as inputs range sensor data including object tracks and camera data. The object track information is used to extract an image patch or a defined area of interest in the visual data corresponding to object track information. Next, areas in the image patch are analyzed and features or patterns in the data indicative of an object in the patch are extracted. The extracted features are then classified according to any number of classifiers. An exemplary classification can include classification as a fast moving object, such a vehicle in motion, a slow moving object, such as a pedestrian, and a stationary object, such as a street sign. Data including the classification is then analyzed according to data association in order to form a vision fused based track. These tracks and associated data regarding the patch are then stored for iterative comparison to new data and for prediction of relative motion to the vehicle suggesting a likely or imminent collision event. Additionally, a region or regions of interest, reflecting previously selected image patches, can be forwarded to the module performing image patch extraction, in order to provide continuity in the analysis of iterative vision data. In this way, range data or range track information is overlaid onto the image plane to improve collision event prediction or likelihood analysis.

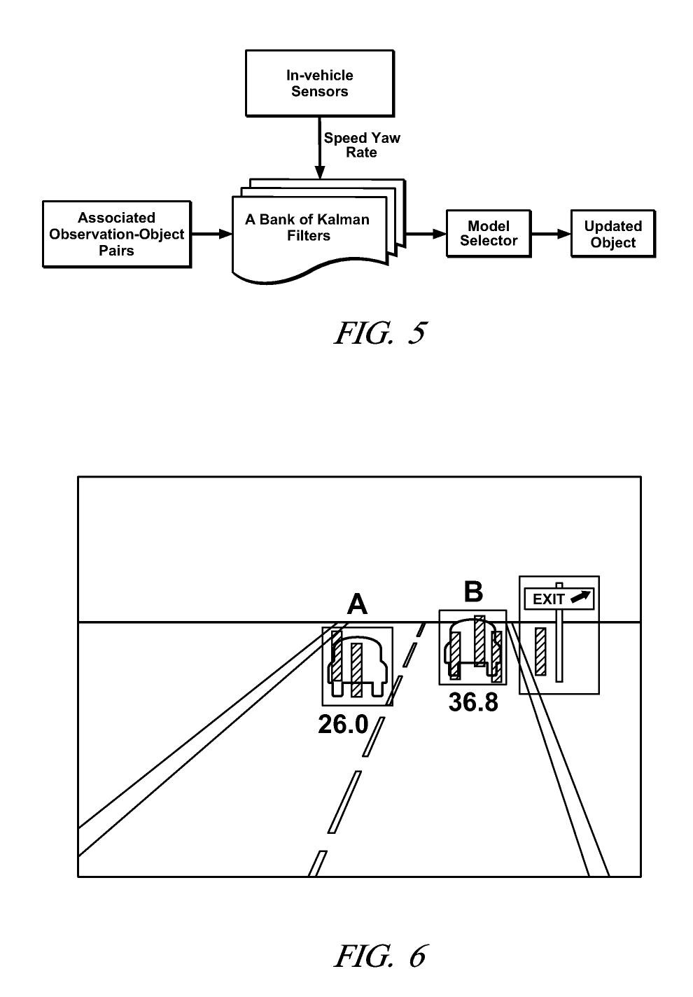

FIG. 5 schematically depicts an exemplary bank of Kalman filters operating to estimate position and velocity of a group of objects, in accordance with the present disclosure. Different filters are used for different constant coasting targets, high longitudinal maneuver targets, and stationary targets. A Markov decision process (MDP) model is used to select the filter with the most likelihood measurement based on the observation and target's previous speed profile. This Multi-model filtering scheme reduces the tracking latency, which is important for CPS function.

FIG. 6 illustrates exemplary range data overlaid onto a corresponding image plane, in accordance with the present disclosure. The shaded bars are the radar tracks overlaid in the image of a forward-looking camera. The position and image extraction module extracts the image patches enclosing the range sensor tracks. The feature extraction module computes the features of the image patches using following transforms: edge, histogram of gradient orientation (HOG), scale-invariant feature transform (SIFT), Harris corner detectors, or the patches projected onto a linear subspace. The classification module takes the extracted features as input and feed to a classifier to determine whether an image patch encloses an object. The classification determines the label of each image patch. For example, in FIG. 6, the boxes A and B are identified as vehicles while the unlabelled box is identified as road-side object. The prediction process module utilizes an object's historical information (i.e., position, image patch, and label of previous cycle) and predicts the current values. The data association links the current measurements with the predicted objects, or determines the source of a measurement (i.e., position, image patch, and label) is from a specific object. In the end, the object tracker is activated to generate updated position and save back to the object track files.

Reaction to likely collision events can be scaled based upon increased likelihood. For example, gentle automatic braking can be used in the event of a low threshold likelihood being determined, and more drastic measures can be taken in response to a high threshold likelihood being determined

Additionally, it will be noted that improved accuracy of judging likelihood can be achieved through iterative training of the alert models. For example, if an alert is issued, a review option can be given to the driver, through a voice prompt, and on-screen inquiry, or any other input method, requesting that the driver confirm whether the imminent collision alert was appropriate. A number of methods are known in the art to adapt to correct alerts, false alerts, or missed alerts. For example, machine learning algorithms are known in the art and can be used to adaptively utilize programming, assigning weights and emphasis to alternative calculations depending upon the nature of feedback. Additionally, fuzzy logic can be utilized to condition inputs to a system according to scalable factors based upon feedback. In this way, accuracy of the system can be improved over time and based upon the particular driving habits of an operator.

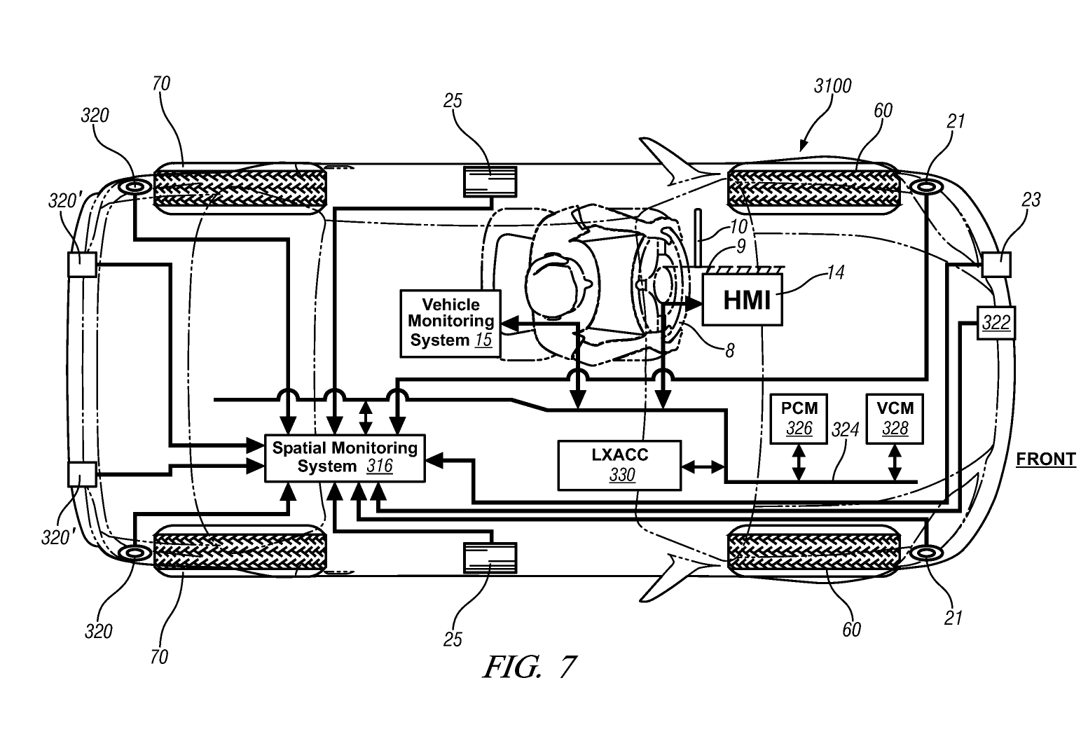

FIG. 7 schematically shows a vehicle 3100 as a four-wheel passenger vehicle with steerable front wheels 60 and fixed rear wheels 70, although the descriptions herein apply to vehicles that are steerable using the front and/or the rear wheels. The subject vehicle 3100 includes a spatial monitoring system 316 and a vehicle monitoring system 15. The subject vehicle 3100 is controlled using a powertrain control module (PCM) 326, a vehicle control module (VCM) 28, and an autonomic control system including a lane change adaptive cruise control (LXACC) system 330. The spatial monitoring system 316, vehicle monitoring system 15, powertrain control module 326, vehicle control module 28, and the LXACC system 330 preferably communicate therebetween using a high-speed local area network communications bus 324. The spatial monitoring system 316, vehicle monitoring system 15, powertrain control module 326, vehicle control module 28, and the LXACC system 330 of the subject vehicle 3100 are shown as discrete elements for ease of description. Control module, module, controller, processor and similar terms mean any suitable one or various combinations of one or more Application Specific Integrated Circuit(s) (ASIC), electronic circuit(s), central processing unit(s) (preferably microprocessor(s)) and associated memory and storage (read only, programmable read only, random access, hard drive, etc.) executing one or more software or firmware programs, combinational logic circuit(s), input/output circuit(s) and devices, appropriate signal conditioning and buffer circuitry, and other suitable components to provide the described functionality. A control module may have a set of control algorithms, including resident software program instructions and calibrations stored in memory and executed to provide the desired functions. The algorithms are preferably executed during preset loop cycles. Algorithms may be executed, such as by a central processing unit, and are operable to monitor inputs from sensing devices and other networked control modules, and execute control and diagnostic routines to control operation of actuators. Loop cycles may be executed at regular intervals, for example each 3.125, 6.25, 12.5, 25 and 100 milliseconds during ongoing engine and vehicle operation. Alternatively, algorithms may be executed in response to occurrence of an event. Although the vehicle operator shown in FIG. 7 is depicted manipulating the steering wheel, embodiments of this disclosure include those in which the driver may be transported by the vehicle with their hands off the wheel for extended time periods.

The spatial monitoring system 316 includes a control module signally connected to sensing devices operative to detect and generate digital images representing remote objects proximate to the subject vehicle 3100. A remote object is said to be proximate to the subject vehicle 3100 when the remote object can be detected by one or more of the sensing devices. The spatial monitoring system 316 preferably determines a linear range, relative speed, and trajectory of each proximate remote object and communicates such information to the LXACC system 330. The sensing devices are situated on the subject vehicle 3100, and include front corner sensors 21, rear corner sensors 320, rear side sensors 320′, side sensors 25, and front radar sensor 322, and a camera 23 in one embodiment, although the disclosure is not so limited. Preferably the camera 23 includes a monochrome vision camera used for detecting forward lane markings. The front radar sensor 322 preferably includes a long-range radar device for object detection in front of the subject vehicle 3100. The front radar sensor 322 preferably detects objects at a distance up to 200 m with a narrow field of view angle of around 15° in one embodiment. Due to the narrow field of view angle, the long range radar may not detect all objects in the front of the subject vehicle 3100. The front corner sensors 21 preferably include short-range radar devices to assist in monitoring the region in front of the subject vehicle 3100, each having a 60° field of view angle and 40 m detection range in one embodiment. The side sensors 25, rear corner sensors 320 and rear side sensors 320′ preferably include short-range radar devices to assist in monitoring oncoming traffic beside and behind the subject vehicle 3100, each having a 60° field of view angle and 40 m detection range in one embodiment. Placement of the aforementioned sensors permits the spatial monitoring system 316 to monitor traffic flow including proximate object vehicles and other objects around the subject vehicle 3100.

Alternatively, the sensing devices can include object-locating sensing devices including range sensors, such as Frequency Modulated Continuous Wave (FM-CW) radars, pulse and Frequency Shift Keying (FSK) radars, and LIDAR devices, and ultrasonic devices which rely upon effects such as Doppler-effect measurements to locate forward objects. The possible object-locating devices include charged-coupled devices (CCD) or complementary metal oxide semi-conductor (CMOS) video image sensors, and other known camera/video image processors which utilize digital photographic methods to ‘view’ forward objects including object vehicle(s). Such sensing systems are employed for detecting and locating objects in automotive applications and are useable with systems including adaptive cruise control, collision avoidance, pre-crash preparation, and side-object detection.

The sensing devices are preferably positioned within the subject vehicle 3100 in relatively unobstructed positions. It is also appreciated that each of these sensors provides an estimate of actual location or condition of an object, wherein said estimate includes an estimated position and standard deviation. As such, sensory detection and measurement of object locations and conditions are typically referred to as estimates. It is further appreciated that the characteristics of these sensors are complementary, in that some are more reliable in estimating certain parameters than others. Sensors can have different operating ranges and angular coverages capable of estimating different parameters within their operating ranges. For example, radar sensors can usually estimate range, range rate and azimuth location of an object, but are not normally robust in estimating the extent of a detected object. A camera with vision processor is more robust in estimating a shape and azimuth position of the object, but is less efficient at estimating the range and range rate of an object. Scanning type LIDAR sensors perform efficiently and accurately with respect to estimating range, and azimuth position, but typically cannot estimate range rate, and are therefore not as accurate with respect to new object acquisition/recognition. Ultrasonic sensors are capable of estimating range but are generally incapable of estimating or computing range rate and azimuth position. Further, it is appreciated that the performance of each sensor technology is affected by differing environmental conditions. Thus, some sensors present parametric variances during operation, although overlapping coverage areas of the sensors create opportunities for sensor data fusion.

The vehicle monitoring system 15 monitors vehicle operation and communicates the monitored vehicle information to the communications bus 324. Monitored information preferably includes vehicle parameters including, e.g., vehicle speed, steering angle of the steerable wheels 60, and yaw rate from a rate gyro device (not shown). The vehicle operation can be monitored by a single control module as shown, or by a plurality of control modules. The vehicle monitoring system 15 preferably includes a plurality of chassis monitoring sensing systems or devices operative to monitor vehicle speed, steering angle and yaw rate, none of which are shown. The vehicle monitoring system 15 generates signals that can be monitored by the LXACC system 330 and other vehicle control systems for vehicle control and operation. The measured yaw rate is combined with steering angle measurements to estimate the vehicle states, lateral speed in particular. The exemplary vehicle system may also include a global position sensing (GPS) system.

The powertrain control module (PCM) 326 is signally and operatively connected to a vehicle powertrain (not shown), and executes control schemes to control operation of an engine, a transmission and other torque machines, none of which are shown, to transmit tractive torque to the vehicle wheels in response to vehicle operating conditions and operator inputs. The powertrain control module 326 is shown as a single control module, but can include a plurality of control module devices operative to control various powertrain actuators, including the engine, transmission, torque machines, wheel motors, and other elements of a hybrid powertrain system, none of which are shown.

The vehicle control module (VCM) 28 is signally and operatively connected to a plurality of vehicle operating systems and executes control schemes to control operation thereof. The vehicle operating systems preferably include braking, stability control, and steering systems. The vehicle operating systems can also include other systems, e.g., HVAC, entertainment systems, communications systems, and anti-theft systems. The vehicle control module 28 is shown as single control module, but can include a plurality of control module devices operative to monitor systems and control various vehicle actuators.

The vehicle steering system preferably includes an electrical power steering system (EPS) coupled with an active front steering system (not shown) to augment or supplant operator input through a steering wheel 8 by controlling steering angle of the steerable wheels 60 during execution of an autonomic maneuver including a lane change maneuver. An exemplary active front steering system permits primary steering operation by the vehicle operator including augmenting steering wheel angle control when necessary to achieve a preferred steering angle and/or vehicle yaw angle. It is appreciated that the control methods described herein are applicable with modifications to vehicle steering control systems such as electrical power steering, four/rear wheel steering systems, and direct yaw control systems which control traction of each wheel to generate a yaw motion.

The passenger compartment of the vehicle 3100 includes an operator position including the steering wheel 8 mounted on a steering column 9. An input device 10 is preferably mechanically mounted on the steering column 9 and signally connects to a human-machine interface (HMI) control module 14. Alternatively, the input device 10 can be mechanically mounted proximate to the steering column 9 in a location that is convenient to the vehicle operator. The input device 10, shown herein as a stalk projecting from column 9, includes an interface device by which the vehicle operator can command vehicle operation in an autonomic control mode, e.g., the LXACC system 330. The input device 10 preferably has control features and a location that is used by present turn-signal activation systems. Alternatively, other input devices, such as levers, switches, buttons, and voice recognition input devices can be used in place of or in addition to the input device 10.

The HMI control module 14 monitors operator requests and provides information to the operator including status of vehicle systems, service and maintenance information, and alerts commanding operator action. The HMI control module 14 signally connects to the communications bus 324 allowing communications with other control modules in the vehicle 3100. With regard to the LXACC system 330, the HMI control module 14 is configured to monitor a signal output from the input device 10, discern an activation signal based upon the signal output from the input device 10, and communicate the activation signal to the communications bus 324. The HMI control module 14 is configured to monitor operator inputs to the steering wheel 8, and an accelerator pedal and a brake pedal, neither of which are shown. It is appreciated that other HMI devices and systems can include vehicle LCD displays, audio feedback, haptic seats, and associated human response mechanisms in the form of knobs, buttons, and audio response mechanisms.

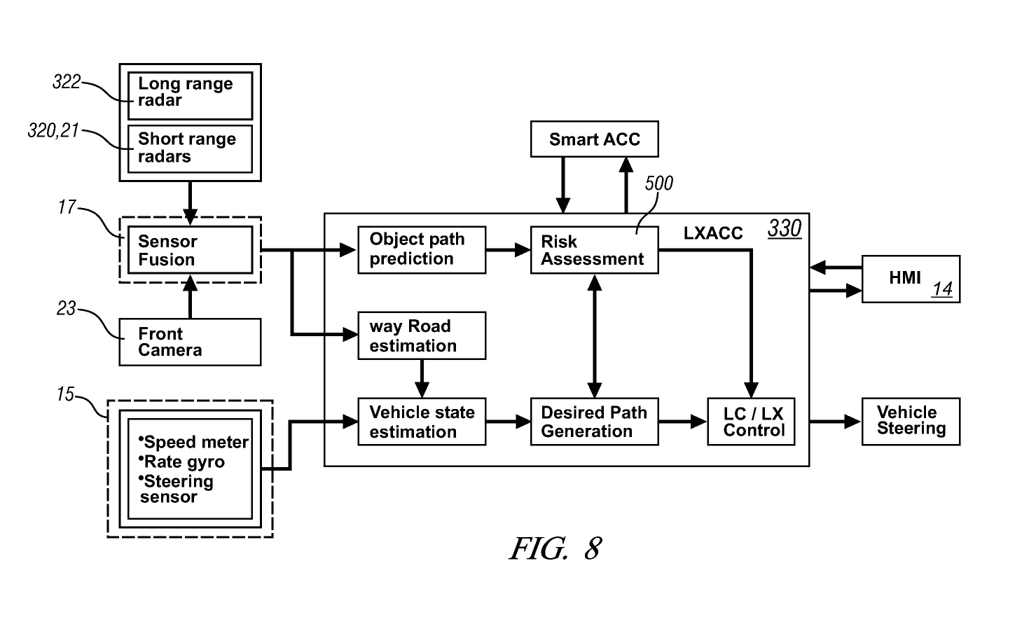

FIG. 8 shows an exemplary control architecture for an autonomic control system including the LXACC system 330 that can be incorporated into the subject vehicle 3100 described with reference to FIG. 7. The LXACC system 330 controls operation of the vehicle 3100 in an autonomic control mode to execute a vehicle maneuver in response to an operator command without direct operator input to the primary vehicle controls, e.g., the steering wheel and accelerator and brake pedals. The LXACC system 330 executes in the autonomic control mode by monitoring inputs from the spatial monitoring system 316 and generating control signals that are transmitted to the powertrain control module 326 and the vehicle control module 28 to control speed and trajectory of the vehicle 3100 to execute the desired vehicle maneuver.

The control architecture for the LXACC system 330 includes core elements for monitoring and controlling the subject vehicle 3100 during ongoing operation. The LXACC system 330 executes in an autonomic lane change mode when it receives an activation signal from the input device 10 via the HMI control module 14.

Overall, the LXACC system 330 monitors signal outputs from the remote sensing and detection devices signally connected to the spatial monitoring system 316. A fusion module (Sensor Fusion) 17 is executed as an element of the spatial monitoring system 316, including algorithmic code to process the signal outputs generated using the sensing devices 320, 320′, 21, 322 and 23 to generate fused objects including digital images representing remote object(s) including object vehicle(s) 3200 proximate to the subject vehicle 3100. The LXACC system 330 uses the fused objects to project a path, or trajectory, for the remote object(s) (Object Path Prediction), e.g., each of one or more object vehicle(s) 3200 that are proximate to the subject vehicle 3100. The LXACC system 330 executes a collision risk assessment scheme 500 for each monitored object (Risk Assessment). The LXACC system 330 decides whether to execute and/or complete a command lane change maneuver based upon the collision risk assessment, which is communicated to an autonomic control module, in this embodiment including a lane change control module (LC/LX Control). The lane change control module of the LXACC system 330 sends control signals to a steering control module (Vehicle Steering) to control vehicle steering and to an autonomic cruise control (Smart ACC) to control vehicle forward motion, including braking and acceleration. The LXACC system 330 can also alert the vehicle operator via the human-machine interface control module 14 subsequent to collision risk assessment.

The spatial monitoring system 316 monitors lane marks and detects neighboring traffic using the aforementioned remote sensing and detection devices. The collision risk assessment scheme 500 of the LXACC system 330 performs collision risk assessment including lateral motion control. The remote sensing and detection devices transmit data to the fusion module for filtering and post-processing. After the post-processing, the fusion module estimates the roadway profile (Roadway Estimation) with reference to the lateral offset of the object vehicle and heading angle of the vehicle 3100 referenced to the current lane. On-board sensors coupled to the vehicle monitoring system 15, including inertial sensors such as a rate gyro, a vehicle speed meter, and a steering angle sensor can be combined with the information from the fusion module to enhance the roadway profile prediction and the vehicle motion state estimation, including, e.g., lateral speed, yaw rate, lateral offset, and heading angle.

The fusion module 17 generates fused objects including the digital images representing the remote objects proximate to the subject vehicle 3100 using information from the forward vision camera, and the long range and short range radars of the spatial monitoring system 316. The information can be in the form of the estimated range, range rate and azimuth location. The sensor fusion system groups data for each of the objects including object vehicle(s) 3200, tracks them, and reports the linear range, relative speed, and trajectory as a present longitudinal distance x, longitudinal relative speed u and longitudinal relative acceleration aₓ, relative to an XY-coordinate system oriented and referenced to the central axis of the subject vehicle 3100 with the X axis parallel to the longitudinal trajectory thereof The fusion module 17 integrates inputs from various sensing devices and generates a fused object list for each of the object vehicle(s) 3200 and other remote objects. The fused object list includes a data estimate of relative location and trajectory of a remote object relative to the subject vehicle 3100, in the form of a fused object list including position (x,y), velocity (Vx, Vy), object width, object type and lane, and a degree of confidence in the data estimate.

In operation the spatial monitoring system 316 determines position, speed and trajectory of other vehicles and objects to identify a clearing sufficient to permit the vehicle 3100 to maneuver into an adjacent travel lane. When there is a sufficient clearing for entry of the vehicle 3100 into the adjacent travel lane, the LXACC system 330 sends a signal indicating lane change availability to the LXACC system 330 via the communications bus 324. Further, the spatial monitoring system 316 can send signals indicative of speed and location of other vehicles, for example, an object vehicle 3200 in the same travel lane directly in front of the vehicle 3100 that can be used to control the speed of the vehicle 3100 as part of an adaptive cruise control system.

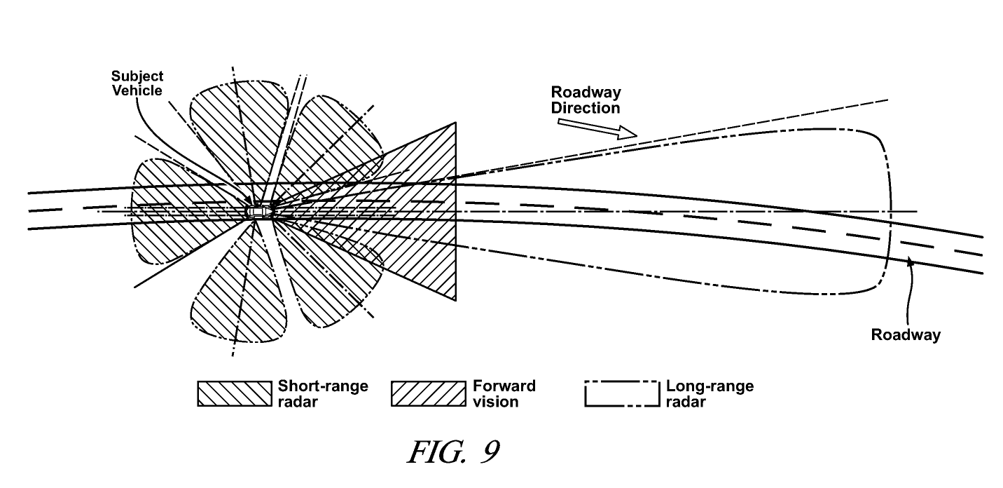

FIG. 9 shows a field of coverage for one embodiment of the aforementioned sensors 320, 320′, 21, and 25 and camera 23 of the spatial monitoring system 316, including relative distance sensing scales for the sensors. One embodiment, covering more than 90% of the static area surrounding the subject vehicle 3100, includes at least three sensors to monitor the lanes in front of and behind the subject vehicle 3100. This redundancy in hardware coverage minimizes a risk of missing proximate approaching objects. Any gaps in reliable coverage are addressed using hysteresis in object tracking and during sensor fusion.

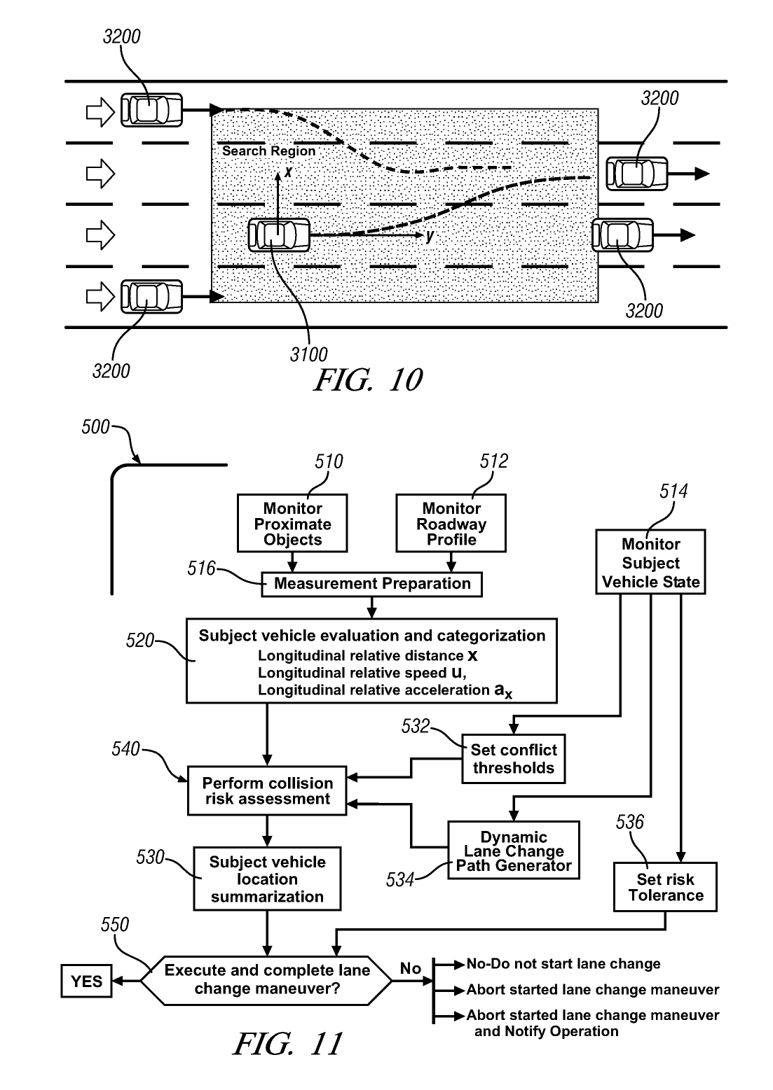

FIG. 10 schematically shows an exemplary search region for a subject vehicle 3100 (SV). The spatial monitoring system 316 is capable of creating a digital image representation of an area around the subject vehicle 3100. The data is translated into the XY-coordinate system referenced to the central axis of the subject vehicle 3100 with the X-axis parallel to the longitudinal trajectory of the subject vehicle 3100. An exemplary field of view for the vision subsystem associated with a lane change maneuver into a left lane is illustrated by the shaded area. A lane of travel on the road is depicted and describes the lane of travel of the object vehicle 3200 and having common features, e.g., lane markers (not shown), that can be detected visually and utilized to describe lane geometry relative to subject vehicle 3100.

In operation, the human-machine interface control module 14 detects an operator input to execute a lane change maneuver and communicates it to the LXACC control module 330. The LXACC control module 330 sends the operating status, diagnosis message, and instruction message to the human-machine interface control module 14, which processes the request, including the collision risk assessment.

FIG. 11 shows a flowchart describing the collision risk assessment scheme 500 when the vehicle operator requests the subject vehicle 3100 to execute a lane change maneuver from a current or host lane to a target lane during ongoing operation. The collision risk assessment process uses model predictive control (MPC) to predict the behavior of a modeled dynamic system, i.e., the object vehicle(s) 3200, with respect to changes in the available measurements. A linear MPC approach is used with the feedback mechanism of the MPC compensating for prediction errors due to structural mismatch between the model and the process. The collision risk assessment scheme 500 uses near future information projected over a short period of time, six seconds in one embodiment, updated at intervals of 50 ms.

The collision risk assessment scheme 500 includes a multi-tiered approach to assess a risk of collision during a lane change maneuver. The spatial monitoring system 316 monitors proximate objects, including each object vehicle(s) 3200 proximate to the subject vehicle 3100 (510) and monitors a roadway profile (512), the outputs of which are provided to a measurement preparation scheme (516), e.g., the fusion module 17 to perform a single object evaluation and categorization (520). The present state of the subject vehicle 3100 is also monitored (514). The present state of the subject vehicle 3100 can be used to determine and set conflict thresholds (532), generate a path for a dynamic lane change maneuver (534), and set risk tolerance rules (536).

The single object evaluation and categorization (520) is executed for each proximate object including object vehicle(s) 3200 relative to the subject vehicle 3100. This includes individually evaluating each object vehicle 3200 using a time-base frame in a two-dimensional plane to project trajectories of the subject vehicle 3100 and each object vehicle 3200. The evaluation preferably includes the longitudinal relative distance x, the longitudinal relative speed u, and the longitudinal relative acceleration aₓ between the subject vehicle 3100 and each object vehicle 3200. Location(s) of the object vehicle(s) 3200 are predicted relative to a projected trajectory of the subject vehicle 3100 at future time-steps.

A collision risk assessment is performed (540) for each object vehicle(s) 3200 associated with the single object evaluation and categorization (520) for object vehicle(s) 3200 in view of the conflict thresholds and the path for the dynamic lane change maneuver. The collision risk assessment associated with each object vehicle(s) 3200 is determined at each of the future time-steps. Performing the collision risk assessment preferably includes generating collision risk information that can be tabulated, e.g., as shown herein with reference to Table 1, below.

The collision risk assessment scheme 500 is based on projected relative trajectories that are determined by three main factors: projected behavior of the object vehicle(s) 3200, road changes, and self-behavior of the subject vehicle 3100. The location(s) of the object vehicle(s) 3200 are predicted relative to a projected trajectory of the subject vehicle 3100 at future time-steps. Projected relative trajectories are determined for the object vehicle(s) 3200, including, e.g., projected speed profiles of each object vehicle(s) 3200 indicating acceleration, slowing down, and hard braking during the period of time the lane change is being executed. The collision risk assessment scheme 500 includes monitoring and accommodating upcoming variations in the road, including lane split/merges, curvatures and banked road and a nonlinear desired trajectory of the subject vehicle 3100 during the lane change.

The collision risk assessment is performed (540) for each object vehicle(s) 3200 associated with the single object evaluation and categorization (520) for object vehicle(s) 3200, location summarization of the subject vehicle 3100 (530), the conflict threshold, the path for the dynamic lane change maneuver. Two criteria to assess collision risk are preferably used. The first criterion includes a longitudinal projection, with the longitudinal, i.e., the X-axis defined as parallel to the trajectory of the subject vehicle 3100. An object vehicle 3200 is said to be a potential risk if it is determined to be longitudinally close, i.e., within an allowable margin, to the subject vehicle 3100 in the next 6 seconds. A second order kinematics equation is used to determine allowable margins for the vehicle heading (front) and vehicle rear as follows.

$$\{ \begin{matrix}\dot{x} = u \\ \dot{u} = {a}_{x}\end{matrix} \qquad [ 1 ]$$

The term x is a longitudinal relative distance between the subject vehicle 3100 and the object vehicle 3200, the term u is the longitudinal relative speed between the subject vehicle 3100 and the object vehicle 3200 in units of meters per second, and the term aₓ is the longitudinal relative acceleration in units of meters per second per second. The relative distance, relative speed, and relative acceleration are defined between the subject vehicle 3100 and each of the object vehicle(s) 3200.

Allowable longitudinal margins including a heading margin and a rear margin are defined as follows to determine whether the subject vehicle 3100 and each of the object vehicle(s) 3200 are too close to each other, i.e., whether there is a collision risk. The heading margin is calculated as follows:

Heading Margin=max(SVLonSpd*½, L m) [2]

wherein SVLonSpd is the longitudinal speed of the subject vehicle 3100. Specifically, the heading margin is the maximum value of the distance the subject vehicle 3100 travels in 0.5 seconds (SVLonSpd*0.5) and a fixed distance of L meters. The fixed distance of L meters is 10 meters in one embodiment.

The rear margin is calculated as follows.

Rear Margin=max(SVLonSpd*⅓, 8) [3]

Specifically, the rear margin is the maximum value of the distance the subject vehicle 3100 travels in 0.33 seconds (SVLonSpd*0.33) and a fixed distance of L2 meters. The fixed distance of L2 meters is 8 m in one embodiment.

The second criterion includes a lateral projection of the object vehicle 3200 with a lateral axis defined as being orthogonal to the trajectory of the subject vehicle 3100 in the two-dimensional plane. The lateral offsets of targets are assumed to remain unchanged relative to the path of the lanes of travel. Here, the predicted relative lateral positions of the object vehicle 3200 are subtracted from the projected future lateral displacements of the subject vehicle 3100 along its desired lane change path, which is dynamically generated according to current vehicle status and steering input position.

A collision risk associated with the second criterion can be identified for an object vehicle 3200 when the object vehicle 3200 is laterally close to the subject vehicle 3100 in the direction of the intended lane change, e.g., when the object vehicle 3200 occupies the target lane of the subject vehicle 3100. This is referred to as an occurrence of a lateral overlap. Roadway information can be used when objects on a curved road are mapped onto a straight road. The lateral offset of the subject vehicle 3100 from lane center, subject vehicle orientation against lane direction and host lane curvature are updated every 50 ms.

A correct virtual reference of the surrounding environment is useful for correctly determining which lane the object vehicle(s) 3200 is driving on. Thus, each step preferably includes a continuous transformation of the XY coordinate defined by the subject vehicle 3100 and relative to the roadway surface, whether in a straight line or curved. In a lane change maneuver, the subject vehicle 3100 moves across a lane marker, but the subject vehicle 3100 may not be in the center of the lane, thus a change in the reference coordinate system is necessary for appropriate decision making. The origin and orientation of the subject vehicle 3100 changes with time. Preferably the reference coordinate is placed at the center of the lane of travel of the subject vehicle 3100 and with longitudinal axis Y aligned with the lane of travel. When measurements are made using the spatial monitoring system, relative coordinates of each object vehicle 3200 can be tracked accordingly with geometric rotation and shift.

In terms of the accuracies of roadway measurements,

Curvature≦Orientation (at x=0)≦Lateral offset (at x=0). [4]

On-board measurement (x, y) is the relative position from sensors and object fusion. Orientation is defined as the angle starting from the x-axis to a tangent of path at the current position of the subject vehicle 3100. The coordinate (x′, y′) is obtained by rotating at a center of gravity of the subject vehicle 3100 and aligning longitudinal direction with the roadway. The origin is shifted back to a center of the present host lane in order to orient the coordinate (X, Y) in a virtual vehicle framework, where a virtual subject vehicle 3100 is cruising along the centerline of the current lane at a current speed. The last step of preparation includes projecting object vehicle movement onto straight lanes parallel to the host lane. By doing so, the interactions between road complexity and target motion can be decoupled. The steering of all the moving vehicles due to road profile change is removed from their relative motion.

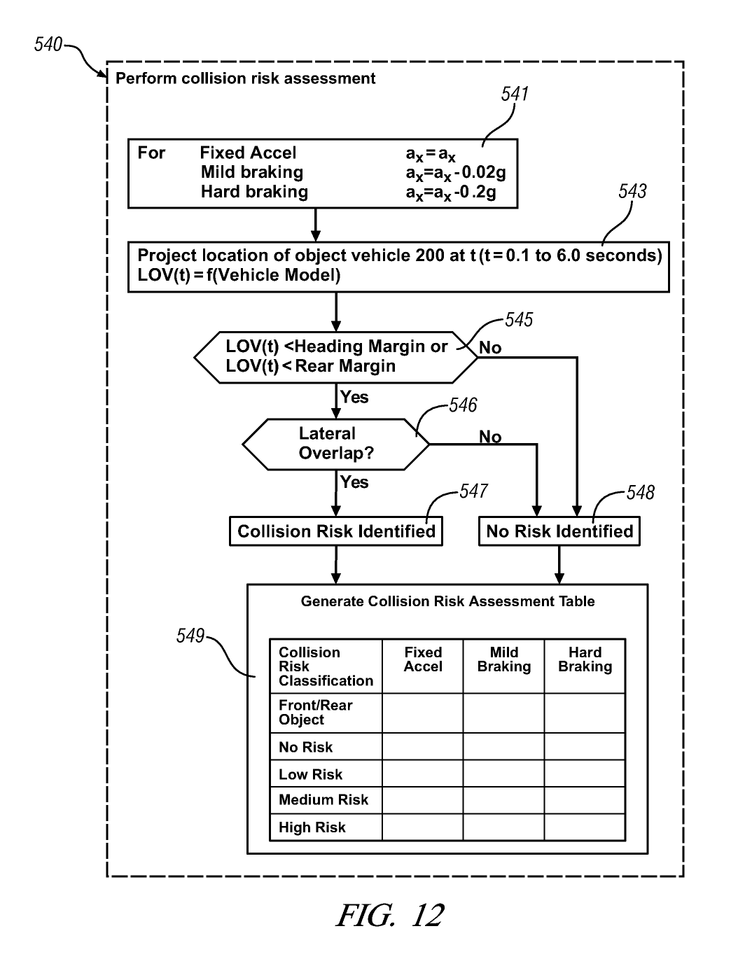

FIG. 12 shows an exemplary collision risk assessment process (540). Preferably, the LXACC 330 collects and analyzes data every 50 ms for each object vehicle 3200 and calculates the heading and rear margins every 100 ms for each object vehicle 3200. A range of potential operating behaviors of each object vehicle 3200 are selected, including potential longitudinal acceleration rates in one embodiment. The selected longitudinal acceleration rates include a present acceleration rate, mild braking, and hard braking. Mild braking is defined as 0.02 g and hard braking is defined as 0.2 g in one embodiment (541). Other selected acceleration rates can be used depending upon vehicle dynamic capabilities. Location of each object vehicle 3200 is projected and a longitudinal relative distance LOV(t) is projected between the subject vehicle 3100 and each object vehicle(s) 3200 based upon the present longitudinal distance x, the longitudinal relative speed u and the longitudinal relative acceleration aₓ under three sets of conditions for acceleration, for time periods projecting into the future from 100 ms to 6.0 seconds at 100 ms intervals based upon a predetermined vehicle model (543). One exemplary kinematic vehicle model is set forth as follows.

LOV(t)=x+u*(t)+0.5aₓ*(t)² [5]

The projected longitudinal relative distance LOV(t) for each of the time periods for each set of acceleration conditions is compared to the heading margin and the rear margin to detect any longitudinal overlap with the heading margin or the rear margin in the forthcoming six seconds (545). When a risk of longitudinal overlap is identified, it is evaluated whether there is a lateral overlap (546). A risk of collision with each object vehicle 3200 is identified when the projected longitudinal relative distance LOV(t) is within one of the heading margin and the rear margin in the forthcoming six seconds and there is lateral overlap (547). The criteria of classification are mirrored for front objects and rear objects because the same braking effort has different effects on front object vehicles and rear object vehicles in terms of relative distances. Risk assessment includes classifying the risk of collision as one of no risk, low risk, medium risk and high risk.

There is said to be no risk of collision when there is no combination of longitudinal overlap between one of the heading margin and the rear margin and the projected longitudinal relative distance LOV(t) and no lateral overlap, as evaluated for each of the time periods for each set of acceleration conditions including fixed acceleration, mild braking and hard braking. There is said to be a low risk of collision when there is a combination of lateral overlap and longitudinal overlap between one of the heading margin and the rear margin and the projected longitudinal relative distance LOV(t) for any of the time periods only when the acceleration conditions include hard braking.

There is said to be a medium risk of collision when there is a combination of lateral overlap and longitudinal overlap between one of the heading margin and the rear margin and the projected longitudinal relative distance LOV(t) for any of the time periods when the acceleration conditions include mild braking and hard braking.

There is said to be a high risk of collision when there is a combination of lateral overlap and longitudinal overlap between one of the heading margin and the rear margin and the projected longitudinal relative distance LOV(t) for any of the time periods under any of the acceleration conditions.

An exemplary collision risk assessment table (549) is shown in Table 1:

TABLE 1

| | Object vehicle 3200 | | |
|---|---|---|---|
| Risk of | Fixed | Mild Braking | Hard Braking |
| Collision | Acceleration | (−0.02 g) | (−0.2 g) |

Front Object

| | | | |
|---|---|---|---|
| No Risk | -No- | -No- | -No- |
| Low Risk | -No- | -No- | -Yes- |
| Medium Risk | -No- | -Yes- | -Yes- |
| High Risk | -Yes- | -Yes- | -Yes- |

Rear Object

| | | | |
|---|---|---|---|
| No Risk | -No- | -No- | -No- |
| Low Risk | -Yes- | -No- | -No- |
| Medium Risk | -Yes- | -Yes- | -No- |
| High Risk | -Yes- | -Yes- | -Yes- |

wherein—Yes—indicates there is a risk of a collision in the next 6 seconds, and—No—indicates no risk of a collision in the next 6 seconds.

A location summarization of the subject vehicle 3100 is then determined (530). Preferably, the surrounding location of the subject vehicle 3100 is divided into six areas, including a front host lane, middle host lane, rear host lane, front target lane, side target lane, and rear target lane. A single metric for level of collision risk is used for the six areas to summarize all single object categories. The resulting six metrics become relatively more robust with respect to object detection. For example, when one object vehicle 3200 cuts in the front target lane from a merging ramp while another object vehicle 3200 leaves to exit the highway at the same time, the location metric will not become on and off. This will help prevent undesirably sending out temporary road availability. Regardless of the quantity of valid object vehicle(s) 3200 and other proximate objects proximate, the risk assessment for each of the areas is determined on an ongoing basis.

Setting the risk tolerance rules includes determining for the subject vehicle 3100 whether a lane change maneuver has been requested, whether a lane change maneuver has started, and whether a lane boundary has been crossed subsequent to requesting and initiating the lane change maneuver. One of a conservative risk tolerance, a moderate risk tolerance, and an aggressive risk tolerance is selected accordingly (536).

The lane change control decision-making includes granting or denying permission to execute and/or complete the requested lane change maneuver in response to the collision risk assessment in view of the risk tolerance rules (550). Permission for the subject vehicle 3100 to start and/or complete a requested lane change maneuver is granted or denied based upon the collision risk assessment and risk tolerance rules. The collision risk assessment scheme preferably executes ongoingly during vehicle operation, including before and during execution of an autonomic lane change maneuver until completion thereof, taking into account the trajectory of the subject vehicle 3100.

Thus, subsequent to commanding a lane change maneuver, it is determined whether a lane change has started and whether a lane boundary has been crossed. One of the conservative risk tolerance, the moderate risk tolerance, and the aggressive risk tolerance is selected based thereon (536). The conservative risk tolerance permits execution of the requested lane change maneuver only when there has been no collision risk in the most recent 0.3 seconds. The moderate risk tolerance permits execution of the requested lane change maneuver only when the collision risk is low or no risk. The aggressive risk tolerance permits execution of the requested lane change maneuver only when the collision risk is medium or less. The collision risk assessment is performed (540) for each 100 ms period projecting 6 seconds into the future for each object vehicle 3200 within a field of view of the subject vehicle 3100 in one embodiment, and the appropriate risk tolerance is applied to each assessment corresponding to whether a lane change has started, and whether a lane boundary has been crossed. Potential outcomes of the collision risk assessment control scheme (500) include permitting the lane change maneuver, inhibiting the lane change maneuver or warning the operator prior to starting the lane change maneuver, aborting the started lane change maneuver and returning to the original lane, and aborting the started lane change maneuver and notifying and demanding operator action.

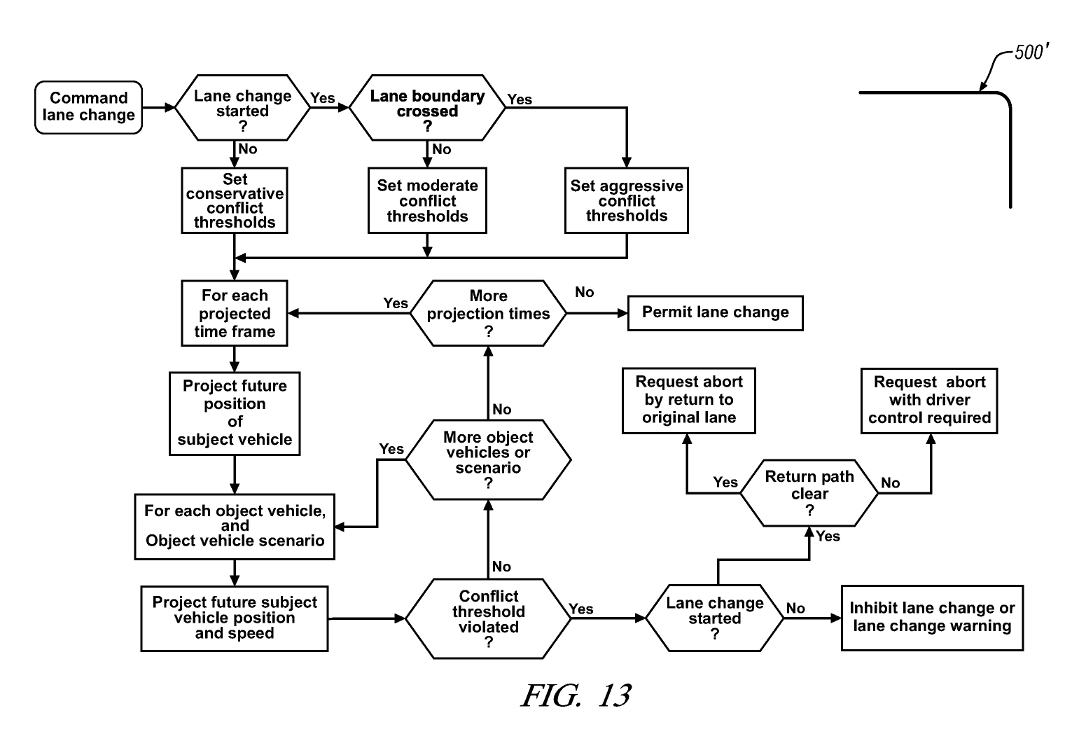

FIG. 13 depicts an embodiment of the exemplary control scheme 500′ executed by the LXACC system 330 to execute and apply collision risk assessment before and during a lane change maneuver, using the collision risk classification depicted in Table 1. Lane change decision-making includes permission to execute and/or complete a lane change maneuver, and is associated with the collision risk assessment and the location summarization of the subject vehicle 3100.

In operation, the collision risk assessment scheme 500′ analyzes the lane and traffic information and compares them with the desired lane change path predicted constantly based on the status and location of the subject vehicle 3100. If a collision is predicted when a lane change is requested, the maneuver will be on hold temporarily until the related lanes are empty or have enough spatial safety margins to carry out this action. If a collision is predicted during the lane change, the maneuvering will have two options of aborting action, which depends on the then current situation. The LXACC system 330 forces the vehicle go back to its original lane whenever this can be done safely; otherwise the lane change is aborted and control is yielded to the vehicle operator.

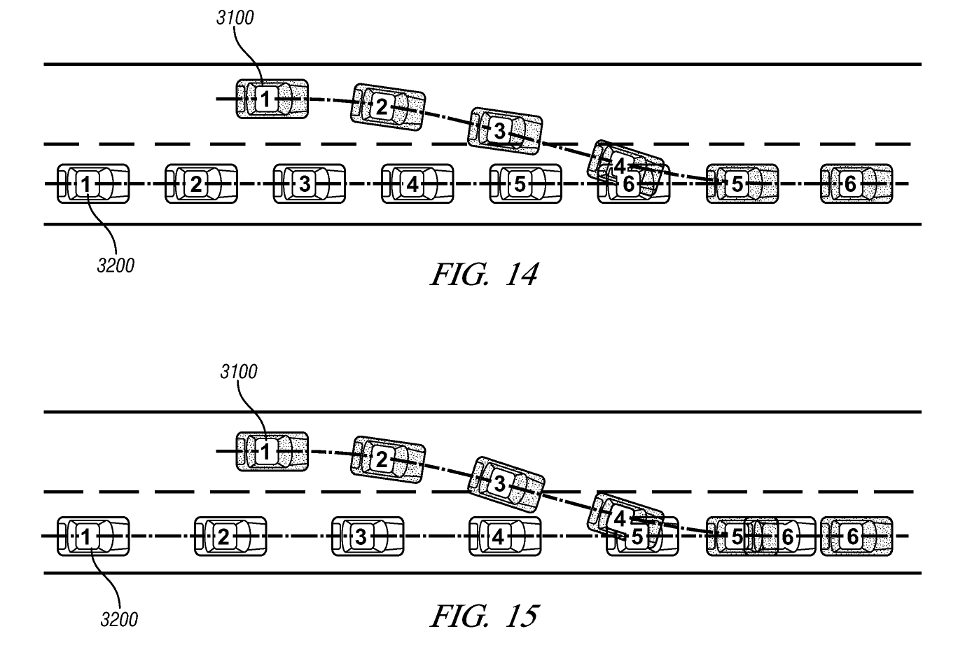

FIGS. 14 and 15 schematically illustrate a roadway including a subject vehicle 3100 and an object vehicle 3200 over time during execution of a lane change maneuver in accordance with the collision risk assessment scheme 500 described herein. Integers 1, 2, 3, 4, 5, and 6 indicate elapsed time in seconds and the vehicles indicate locations of the subject vehicle 3100 and object vehicle 3200 at corresponding points in time. FIG. 14 shows the subject vehicle 3100 occupies a location after 4 seconds, and the object vehicle 3200 occupies the same location after 6 seconds. The collision risk assessment scheme indicates a permissible lane change maneuver. FIG. 15 shows the subject vehicle 3100 occupies a location after 4 seconds, and the object vehicle 3200 occupies the same location after 5 seconds. The collision risk assessment scheme does not indicate a permissible lane change maneuver, and causes the LXACC system 330 to stop or abort the lane change maneuver.

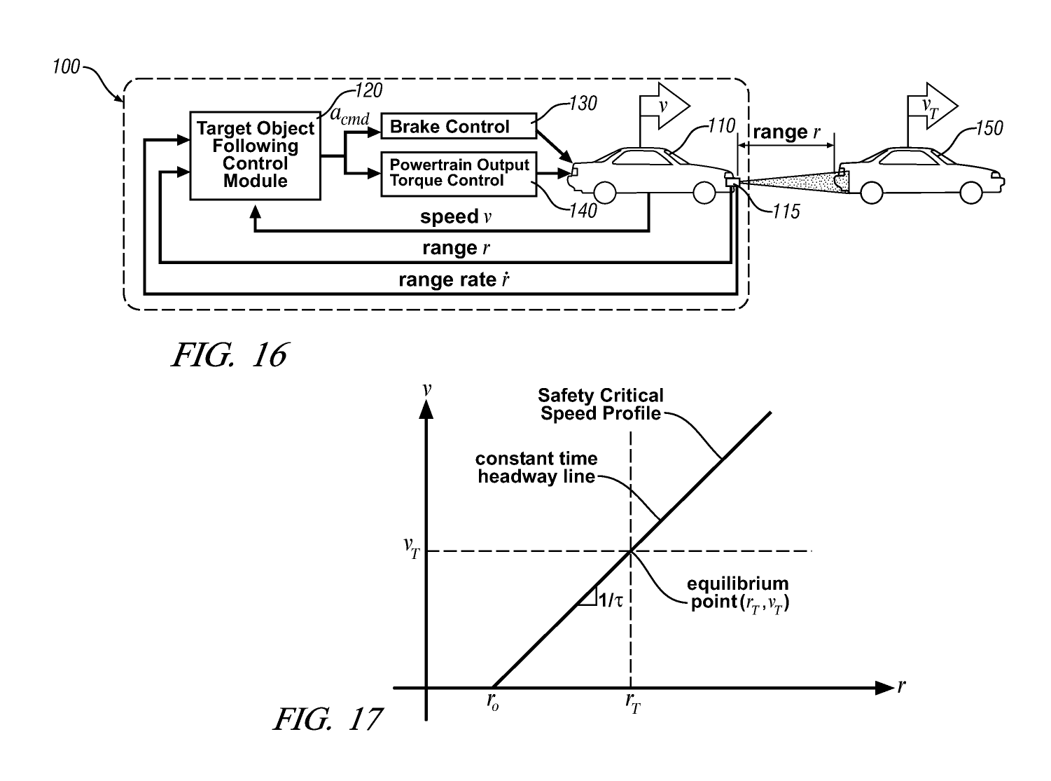

FIG. 16 depicts an exemplary target vehicle following control system, in accordance with the present disclosure. Target vehicle following control system 100 includes host vehicle 110, sensing device 115, target object following control module 120, brake control module 130, and powertrain output torque control module 140. Additionally, target vehicle 150 is depicted. The various modules are pictured separately from host vehicle 110 for purposes of describing the effect of the various modules upon v; however, it will be appreciated that these modules are either physically situated within host vehicle 110 or are available to host vehicle 110 such as over a communications network. Host vehicle 110 is traveling at speed v, and sensors internal to host vehicle 110 generate a signal describing v. Target vehicle 150 is traveling at speed v_{T}. Sensing device 115 integral to host vehicle 110 gathers data regarding r and r_dot. Target object following control module 120 monitors inputs of v, r, and r_dot. Applying methods described herein, module 120 outputs an acceleration command (a_{cmd}) describing a desired change in v. Depending upon the magnitude and sign of a_{cmd} corresponding to a desired increase or decrease in v, brake control module 130 and powertrain output torque control module 140 issue a braking command from module 130, activating brakes to apply a slowing force upon wheels of the vehicles; an output torque command from module 140, changing the torsional force applied through the drivetrain to the wheels; or both. The effects of the commands from modules 130 and 140 effect the operation of host vehicle 110 and resulting v. In this way, target vehicle following control system 100 controls v in a closed feedback loop based upon v, r, and r_dot.

Powertrain output torque control module 140 controls various components of the powertrain to affect output torque applied to the wheels of the vehicle. In this way, V can be controlled within certain limits, depending upon the particulars of the powertrain employed. In a powertrain including an internal combustion engine, changes to output torque can be affected by a simple change in throttle setting. Desired increases in v can be achieved by demanding a greater output torque. One having ordinary skill in the art will appreciate that such changes in throttle setting take a relatively longer time to enact than other changes to output torque from an engine. For example, ignition timing or fuel injection timing can be altered to more quickly temporarily reduce output torque by reducing the efficiency of combustion within the engine. In a powertrain including an electric motor or motors, for example, in a hybrid drive powertrain, output torque can be cut by reducing the torque contribution of an electric machine. In such a powertrain, it will be appreciated that an electric motor can be operated in a generator mode, applying an output torque in the reverse or braking direction and thereby allowing reclamation of energy to an energy storage device. The embodiments described illustrate a number of examples by which output torque changes can be commanded. Many methods for changing output torque are known in the art, and the disclosure is not intended to be limited to the particular embodiments described herein.

Sensing device 115 provides a data stream of information including at least r and r_dot. Sensing device 115 can represent a single sensor, a single sensor combined with a processor, a multitude of sensors, or any other known configuration capable of generating the required data stream. One preferred embodiment includes known radar devices. The radar device attached to the host vehicle detects r (the distance between the two vehicles), and r_dot (relative speed of the target vehicle with respect to the host vehicle) for use by the target vehicle following control system.

As described above, target object following control module 120 inputs data regarding the conditions in the lane in front of the host vehicle, monitoring at least v, r, and r_dot. Module 120 output a_{cmd} is useful to control the vehicle into desired ranges of operation with respect to the target vehicle. Module 120 can include a program or a number of programs to utilize the inputs, applying calibrated relationships and desired values to achieve the necessary balance of the vehicle either to static lane conditions or dynamic lane conditions. Exemplary embodiments of this programming are described herein, however it will be appreciated that the overall methods described herein can be achieved through a number of different programming embodiments seeking to achieve the enabled balance between safety, drivability, and other concerns necessary to ACC in a moving vehicle. Programming techniques and methods for data manipulation are well known in the art, and this disclosure is not intended to be limited to the particular exemplary programming embodiments described herein.

As described above, ACC is a method whereby a host vehicle speed is controlled according to a desired speed, as in common cruise control, and additionally, speed control is performed based upon maintaining a particular range from a target vehicle in front of the host vehicle. Selecting a reference speed based upon the target vehicle's position and relative speed to the host vehicle is based upon a desired range. Selection of the desired range that the vehicle is controlled to achieved through a calibration process, wherein range between vehicles is set based upon values balancing a number of preferences, including but not limited to balancing reasonable distances to operator safety concerns. Control according to the desired range values can take many forms. One embodiment includes utilizing a sliding mode control, a control technique that brings the state of the system into a desired trajectory, transitioning range to a desired value, called sliding surface. In ACC applications, the state is range and speed of the vehicle and we want to make the range-speed state follow the desired trajectory. The sliding mode control makes it possible for the ACC system to keep its range-speed state on the desired speed profile which is equivalent to the sliding surface.

An exemplary method for operating a target vehicle following control system is disclosed. Control programming first calculates the speed of the target vehicle from the sensor signals as follows.

v_{T}=v+\dot{r} [6]

The control algorithm then determines reference host vehicle speed vᵣ(r,v_{T}) which is function of range r and the target vehicle speed v_{T}.

The control objective of the target vehicle following control system is to keep the host vehicle speed v same as the reference speed vᵣ(r,v_{T}). A speed error can be defined between the reference speed and the host vehicle speed by the following equation.

ε:e=vᵣ(r,v_{T})−v [7]

The control objective can be achieved by using sliding mode control by selecting the sliding surface to e.

To derive the sliding mode control, one can first account for longitudinal dynamics of the host vehicle. When acceleration command a_{cmd} is applied, the longitudinal equation of motion of the vehicle can be expressed by the following equation.

\dot{v}=a_{cmd}−d [8]

The value of d is assumed to be unknown but constant disturbance representing road grade and air-drag. A Lyapunov function can be expressed by the following equation.

$$V = \frac{1}{2} {γ}_{I} {e}^{2} + \frac{1}{2} {( q - d )}^{2} \qquad [ 9 ]$$

The term γ_{I}>0 is integral control gain, and q is the integration of the speed error, i.e., \dot{q}=γ_{I}e. The time derivative of the Lyapunov function expressed in Equation 9 can be expressed as the following equation.

\dot{V}=γ_{I}ee+(q−d)\dot{q}=γ_{I}e(ė+q−d) [10]

The time derivative of Equation 7 can be expressed by the following equation.

$$\dot{e} = \frac{d}{d t} {v}_{r} ( r , {v}_{T} ) - \dot{v} \qquad [ 11 ]$$

By substituting Equation 8 into Equation 11, the following equation can be expressed.

$$\dot{e} = \frac{d}{d t} {v}_{r} ( r , {v}_{T} ) - {a}_{cmd} + d \qquad [ 12 ]$$

Therefore, Equation 10 can be expressed by the following equation:

$$\dot{V} = {γ}_{I} e \{ \frac{d}{d t} {v}_{r} ( r , {v}_{T} ) - {a}_{cmd} + q \} where \dot{q} = {γ}_{I} e . \qquad [ 13 ]$$

If we choose the following control law,

$${a}_{cmd} = {a}_{r} + {γ}_{p} e + q \\ where {a}_{r} = \frac{d}{d t} {v}_{r} ( r , {v}_{T} ) , {γ}_{p} > 0 and \dot{q} = {γ}_{I} e , \qquad [ 14 ]$$

then Equation 13 can be expressed by the following equation.

\dot{V}=γ_{I}γₚe²<0, ∀e≠0,(d−q)≠0 [15]

Therefore, Equation 14, the control law, guarantees that the error e to the sliding surface converges to zero as time goes to infinity. Once the state is on the surface, therefore, the trajectory becomes a stable invariant set, and the state remains on the surface.

With regard to selection of the vᵣ, a speed profile vᵣ(r,v_{T}) that satisfies the following two conditions qualifies for the reference host vehicle speed profile.

v_{T}=vᵣ(r_{T},v_{T}) [16]

(r−r_{T})(vᵣ−v_{T})>0 ∀r≠r_{T} [17]

Equation 16 states that the profile should pass through the equilibrium point (r_{T},v_{T}), and Equation 17 is the sufficient condition for the stability of the system on the profile as discussed below. Assuming the range-speed state is already on the profile and the control programming keeps the state on the profile, the following equation can be expressed as follows.

v=vᵣ(r,v_{T}) [18]

To study the stability of the system on the profile, one can define the range error by the following equation.

\tilde{r} to be: \tilde{r}=r−r_{T} [19]

Since the speed on the curve is dependent variable of the range, the system on the curve has only one state. If one defines a Lyapunov function which is positive definite with respect to the range error

$$V = \frac{1}{2} {( r - {r}_{T} )}^{2} , \qquad [ 20 ]$$

then the time derivative of Equation 14 can be expressed by the following equation.

$$\frac{d}{d t} V = ( r - {r}_{T} ) \dot{r} = - ( r - {r}_{T} ) \{ {v}_{r} ( r , {v}_{T} ) - {v}_{T} \} \qquad [ 21 ]$$

If the speed profile satisfies Equations 16 and 17, the time derivative expressed in Equation 21 of the Lyapynov function is negative definite with respect to the range error, and hence the system is asymptotically stable.

A safety critical speed profile can be defined for the vᵣ, describing a minimum r that must be maintained for a given vᵣ. FIG. 17 graphically depicts an exemplary safety critical speed profile, in accordance with the present disclosure. One preferred method of defining a safe range is using time headway τ. The time headway is a construct defined as the time for the host vehicle to intersect the target vehicle if the target vehicle instantaneously stops and the host vehicle keeps its current speed. One simple sliding surface (reference speed profile) is the constant time headway line itself shown in FIG. 17. This constant time headway line can be expressed by the following equation.

vᵣ=v_{T}+(r−r_{T})/τ [22]

If the speed-range state is on the sliding surface, the state stays on the sliding surface while maintaining the time headway. However the acceleration/deceleration on the sliding surface can be very high as speed gets higher, as expressed by the following equation.

$${a}_{r} = \frac{\partial {v}_{d}}{\partial r} \dot{r} = - \frac{( {v}_{d} - {v}_{T} )}{τ} \qquad [ 23 ]$$

This high acceleration/deceleration is acceptable in safety critical situations such as sudden cut-in with short range. However, if the range is long enough, smoother operation with limited acceleration/deceleration is preferred.

FIG. 17 can further be utilized to describe how a vehicle reacts to not being on the safety critical speed profile. For example, for a measured v_{T} value, the control system determines whether the existing r value is in the region above the safety critical speed profile or in the region below the safety critical speed profile. If the existing r value is in the region above the profile, a negative a_{cmd} is generated to decrease output torque commanded of the powertrain, activate braking force, or both in order to increase r to the desired value, r_{T}. If the existing r value is in the region below the profile, a positive a_{cmd} is generated to increase output torque commanded of the powertrain in order to decrease r to the desired value, r_{T}.

As mentioned above, drivability of a host vehicle operated by ACC is an important characteristic in selecting parameters within a target object following control module. Drivability is adversely affected by quick or frequent changes in acceleration, high jerk, or other dynamic factors that detract from smooth operation of the vehicle. For smooth operation, acceleration/deceleration needs to be limited to a certain level. An equation can be expressed to describe the reference speed profile with its acceleration/deceleration limited for smooth operation by the following equations.

$$\begin{matrix}{β}_{o} {v}_{r} = {v}_{T} + \sqrt{2 {β}_{o} ( r - {r}_{T} ) - {β}_{o}^{2} {τ}^{2}} & [ 24 ] \\ {a}_{r} = \frac{d {v}_{r}}{d t} = - {β}_{o} & [ 25 ]\end{matrix}$$

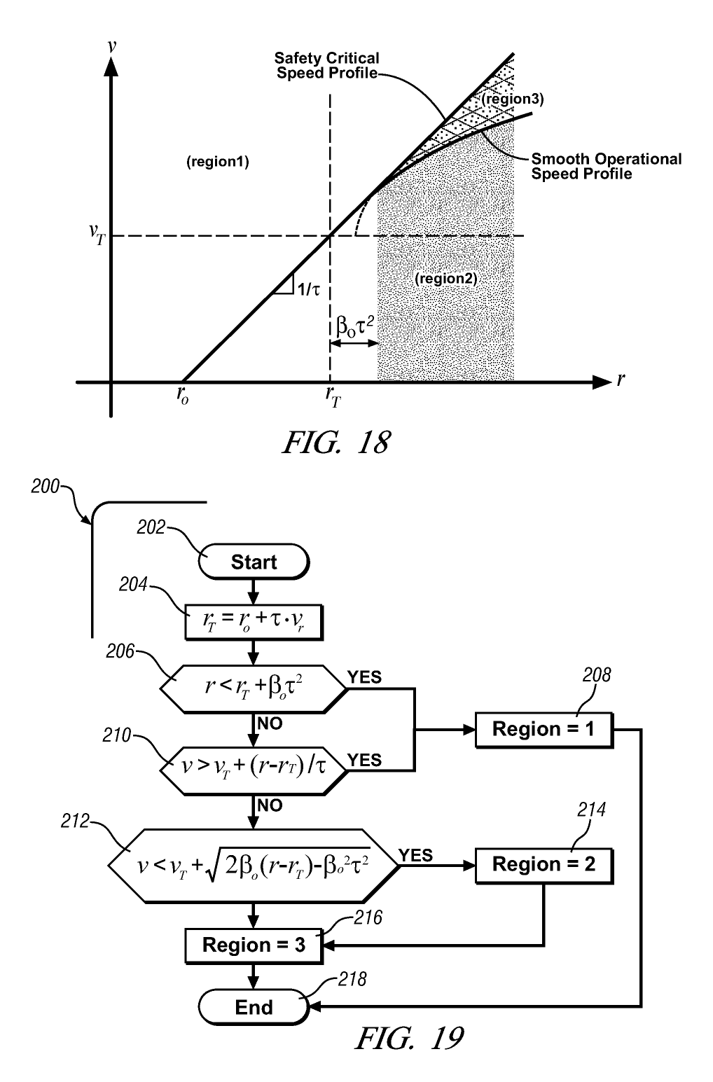

FIG. 18 graphically illustrates an exemplary safety critical speed profile and an exemplary smooth operational speed profile, in accordance with the present disclosure. The safety critical speed profile described in relation to FIG. 17 remains important to controlling the vehicle. The vehicle must be able to stop without collision in the event the target vehicle stops. However, the pictured smooth operational speed profile adds a buffer or a margin of safety at higher speeds, increasing a corresponding range by a larger and larger value the higher speeds go. This buffer and the resulting greater range affords more gradual changes in velocity and acceleration to avoid violating the safety critical speed profile at higher speeds during dynamic conditions.

In relation to FIG. 17, operation of the vehicle with respect to the safety critical speed profile was described according to two regions: one above and one below the profile. In relation to FIG. 18, operation of the vehicle can be described in three regions with respect to the safety critical speed profile and the smooth operational speed profile: Region 1 existing above the safety critical speed profile; Region 2 existing below the safety critical speed profile and the smooth operational speed profile; and Region 3 existing between the safety critical speed profile and the smooth operational speed profile.

FIG. 18 demonstrates use of both safety critical and smooth operational profiles depending on the state of the range-speed and the resulting region in which the vehicle is operating. Based on the two speed-profiles in FIG. 18, the range-speed plane can be used to classify operation of the vehicle into the three named control regions. In this way, programming specific to the requirements of the particular region, characteristics affecting safety, drivability, and other operating concerns, can be utilized to achieve the required result in vehicle operation.

FIG. 19 depicts an exemplary process whereby the control region in which a vehicle is operating can be determined, in accordance with the present disclosure. Region determination process 200 is initiated at step 202. At step 204, r_{T} is determined At steps 206 and 210, r and v, the measured current velocity of the host vehicle, are compared to the established borders for Region 1, and if either variable establishes operation in Region 1, then a Region indicator is set to 1 at step 208. At step 212, v is compared to the established borders for Region 2, and if V establishes operation in Region 2, then the Region indicator is set to 2 at step 214. At step 216, in the event that neither Region 1 nor Region 2 is established, then the Region indicator is set to 3. At step 218, the process is ended.

Once the control region is determined, different speed profile for control algorithm is applied according to the region. If the vehicle state is in Region 1, for example, by a sudden cut-in of a slower target vehicle within short range, immediate and large enough braking is required to avoid collision. In this case the safety critical speed profile is selected for sliding mode control, expressed for example by the following equations.

$$\begin{matrix}{v}_{1} ( r ) = \frac{1}{τ} ( r - {r}_{0} ) & [ 26 ] \\ {a}_{1} ( \dot{r} ) = \frac{d {v}_{d}}{d r} \dot{r} = \frac{\dot{r}}{τ} & [ 27 ]\end{matrix}$$

If the vehicle is in Region 2 (for example, if the slower target vehicle cuts in with sufficiently long range, there is no need for harsh braking, and the smooth operational speed profile is selected for sliding mode control. Such a transition can be expressed by the following equations.

$$\begin{matrix}{v}_{2} ( r , {v}_{T} ) = {v}_{T} + \sqrt{2 {β}_{o} max \{ ( r - {r}_{T} ) , {β}_{o} {τ}^{2} \} - {β}_{o}^{2} {τ}^{2}} & [ 28 ] \\ {a}_{2} = \frac{d {v}_{2}}{d t} & [ 29 ]\end{matrix}$$

If the vehicle is in Region 3, the region defined between safety critical and smooth operation profiles, a constant deceleration control can be utilized. Such exemplary operation can be expressed by the following equations.

$${a}_{3} = - β , β = \frac{( r - {r}_{T} ) - \sqrt{{( r - {r}_{T} )}^{2} - {τ}^{2} {\dot{r}}^{2}}}{{τ}^{2}} , {v}_{3} = v \qquad [ 30 ]$$

The reference acceleration aᵣ and the reference speed vᵣ are then selected according to the identified control region.

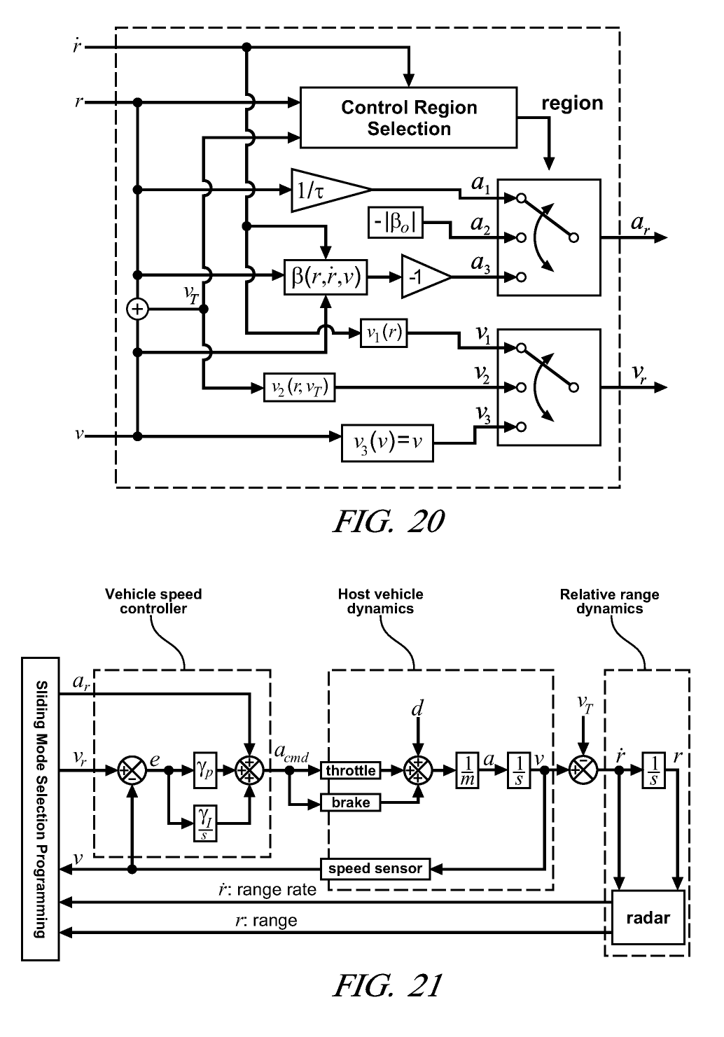

FIG. 20 depicts an exemplary information flow wherein a reference acceleration and a reference speed may be determined, in accordance with the present disclosure. Inputs including r, r_dot, and V are monitored. These inputs are conditioned and processed according to methods described herein. Operation is classified according to the three Regions described above, and various equations for calculation of aᵣ and vᵣ are selected from based upon the classified Region. The resulting aᵣ and vᵣ values are outputs to the flow.

Once the reference acceleration and speed are determined based on the control region, a speed control equation, such as expressed in Equation 14, can be applied. This expression can take the form of the following equation.

a_{cmd}=aᵣ+γₚ(vᵣ−v)+q, where and \dot{q}=γ_{I}(v−vᵣ) [31]

FIG. 21 schematically depicts operation of the above methods combined into a configuration performing the various methods, in accordance with the present disclosure. According to the methods described above, it will be appreciated that the illustrates system can monitor a range with respect to a target vehicle; monitor a range rate with respect to the target vehicle; monitor a speed of the target vehicle; determine an acceleration command based upon the monitored range, the monitored range rate, and the monitored speed; and utilize the acceleration command to control a braking system and an output torque of a powertrain system. A process determining the acceleration command includes classifying current operation, including a current vehicle speed and the range, according to three regions defined by a safety critical speed profile and a smooth operational speed profile. In certain embodiments, it will be appreciated that the smooth operational profile is determined by limiting maximum deceleration. In some embodiments, it will be appreciated that the safety critical profile is determined by time headway. In some embodiments, it will be appreciated that the vehicle speed follows the selected profile by means of sliding mode control. In some embodiments, it will be appreciated that the resulting speed controller includes proportional, integral and feed forward control.

The methods described above depict the various control modules of the method within the host vehicle utilizing a sensing device such as a radar subsystem to establish inputs useful to operating ACC as described herein. However, it will be appreciated that a similar method could be utilized between two cooperating vehicles wherein vehicle to vehicle communication (V2V) and data developed in both cars could be used to augment the methods described herein. For example, two vehicles so equipped traveling in the same lane could communicate such that an application of a brake in the first car could be matched or quickly followed by a speed reduction in the following car. Speed changes in the first car, for example, experienced as a result of a start of a hill, a vehicle speed limit tracking system, or stopping in response to a collision avoidance or preparation system, could likewise be responded to in the second vehicle. Similarly, if a first vehicle in one lane of travel experiences a turn signal or a turn of a steering wheel indicating a change in lane into the area in front of second similarly equipped vehicle in communication with the first, the second vehicle could preemptively change speed to compensate based upon communicated predicted movement of the first vehicle. Similarly, a chain of vehicles could link up and establish a coordinated group of vehicles, linked by the described system, wherein relative motion of the vehicle in front of the chain could be used to predictively control vehicles in the rear of the chain. In some embodiments, for example in commercial trucking applications, such chains could include a tightening of otherwise lengthy desired ranges, particularly in the rear of such a chain, wherein communication from the front vehicles in the chain could be used to increase factors of safety associated with such ranges in the vehicles in the rear, thereby achieving increased fuel efficiency associated with shorter distances between vehicles gained through aerodynamic effects. Many such embodiments utilizing communication between vehicles are envisioned, and the disclosure is not intended to be limited to the particular embodiments described herein.

Simulation studies verify that methods described above can be utilized to control a vehicle in steady state and dynamic lane conditions.

A first scenario was simulated to chase the target vehicle that changes speed between 100 kph and 50 kph. Initially, the host vehicle follows the target vehicle at 100 kph, and the target vehicle reduces its speed down to 50 kph with about 0.3 g deceleration, then the host vehicle responds to the target vehicle to maintain the speed and range. After steady state has been reached, the target vehicle accelerates at about 0.3 g to 100 kph, and the host vehicle also accelerates to follow the target vehicle.

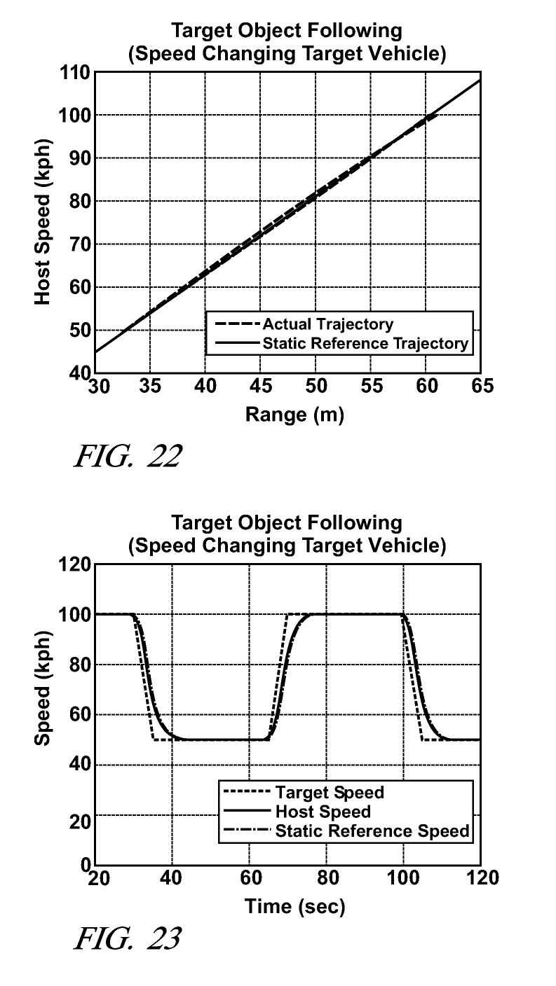

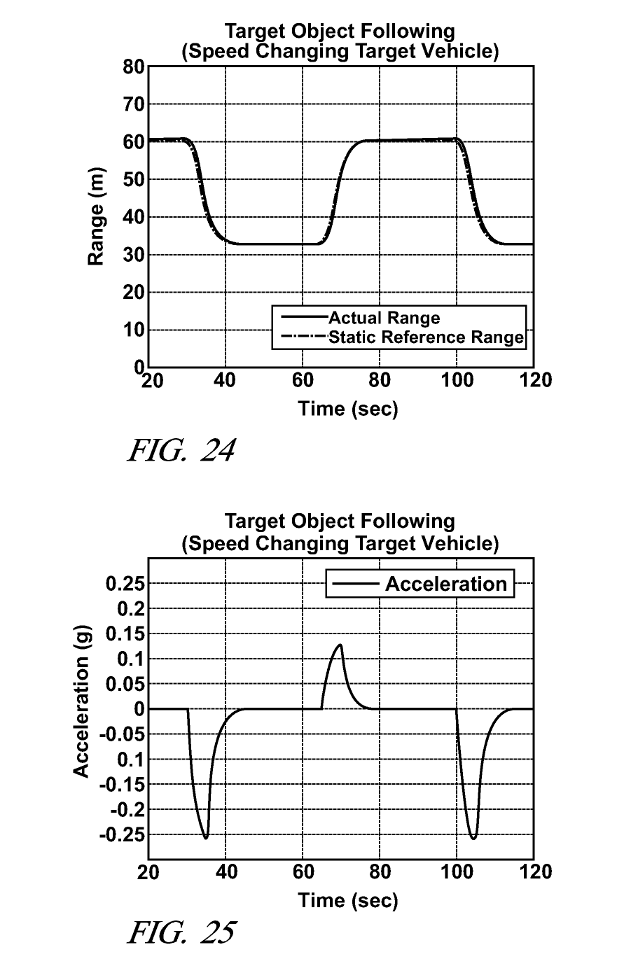

FIGS. 22-25 illustrate the simulation results of the target vehicle chasing scenario described above. As shown in FIG. 22, the speed-range trajectory of the host vehicle remains on the static reference trajectory (sliding surface) regardless of the target vehicle speed. Therefore, FIGS. 23 and 24 show near-perfect tracking of speed and range. Also the acceleration command in FIG. 25 shows a reasonable braking and throttling.

A second scenario was simulated to adjust the speed and range in a moderate cut-in situation. Initially, the host vehicle speed is set to 100 kph. At about 16 second, a target vehicle enters in to the host vehicle lane with the speed of 60 kph and range of 120 m.

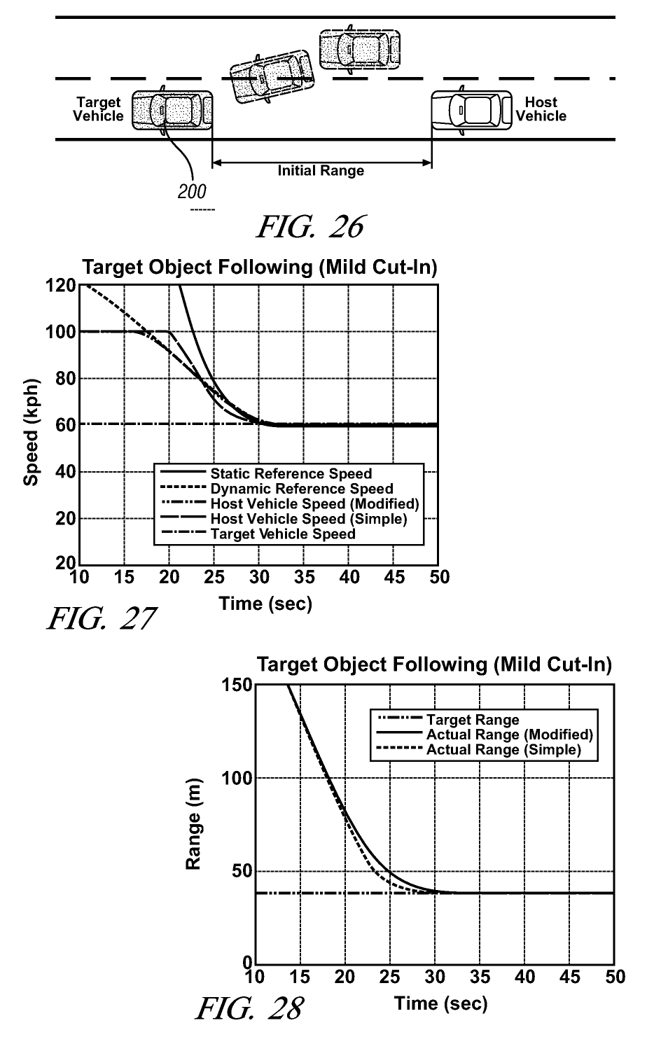

FIG. 26 is a graphical representation of the cut-in scenario.

FIGS. 27-30 show the simulation results comparing simple sliding mode control and modified sliding mode control. As shown in the FIG. 27, the host vehicle keeps its set speed of 100 kph until the range is close enough to initiate braking. Then the host vehicle reduces its speed to very smoothly to 60 kph. With the simple sliding mode control, the initial braking is very late because the state is still off the static sliding surface. With the modified sliding mode control, however, the system applies early braking because the state is close to the profile of reference speed. FIG. 28 shows the corresponding ranges. Both control algorithms achieves the final range with different transient.

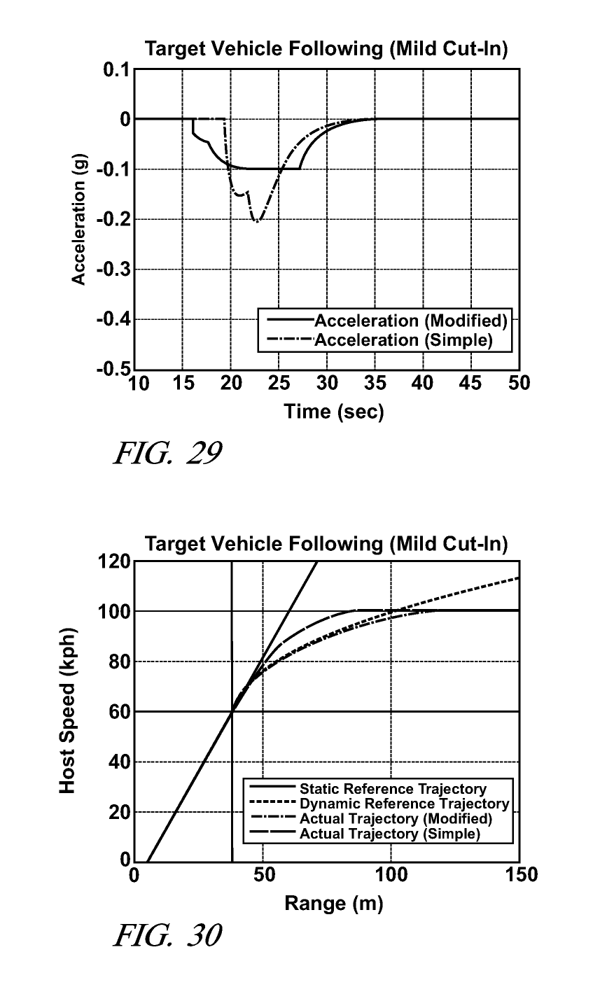

FIG. 29 shows the deceleration command of the two different methods. The simple sliding mode control case applies late braking with higher maximum braking while the modified sliding mode control applies early braking with about 0.1 g of maximum braking. The areas under the braking profile for both controls are the same. Therefore, modified sliding mode control may be preferred for driver's comfort and smooth feeling.

FIG. 30 shows the speed-range trajectory. As shown in the plot, the actual trajectory of simple sliding mode control does not change until the state is close to the static sliding surface. However, the trajectory of the modified sliding control changes its course earlier toward the equilibrium point (38.3 m at 60 kph) along the dynamic profile of reference speed.

An additional scenario was simulated to adjust the speed and range in a moderate cut-in situation. Initially, the host vehicle speed is set to 100 kph. At about 20 second, a target vehicle enters in to the host vehicle lane with the speed of 60 kph and range of 80 m.

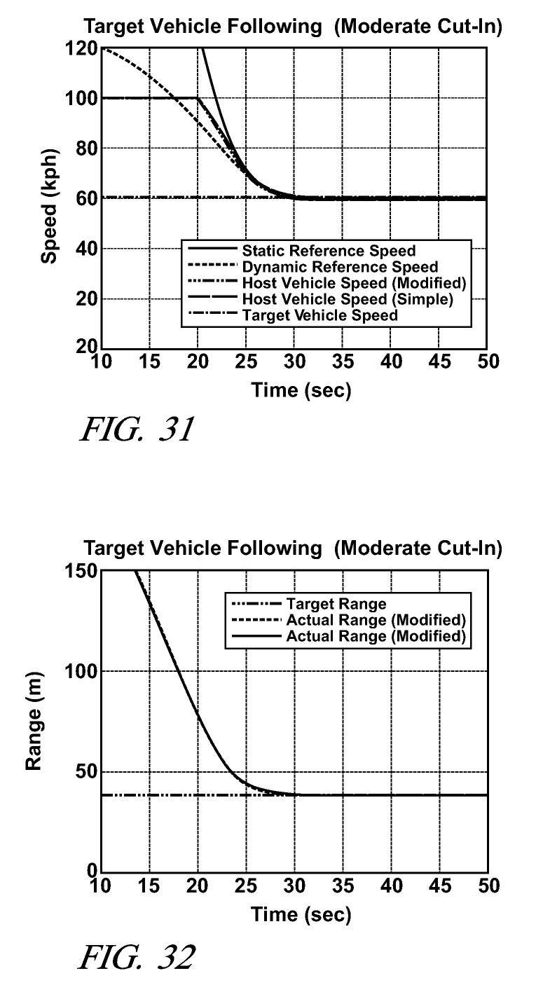

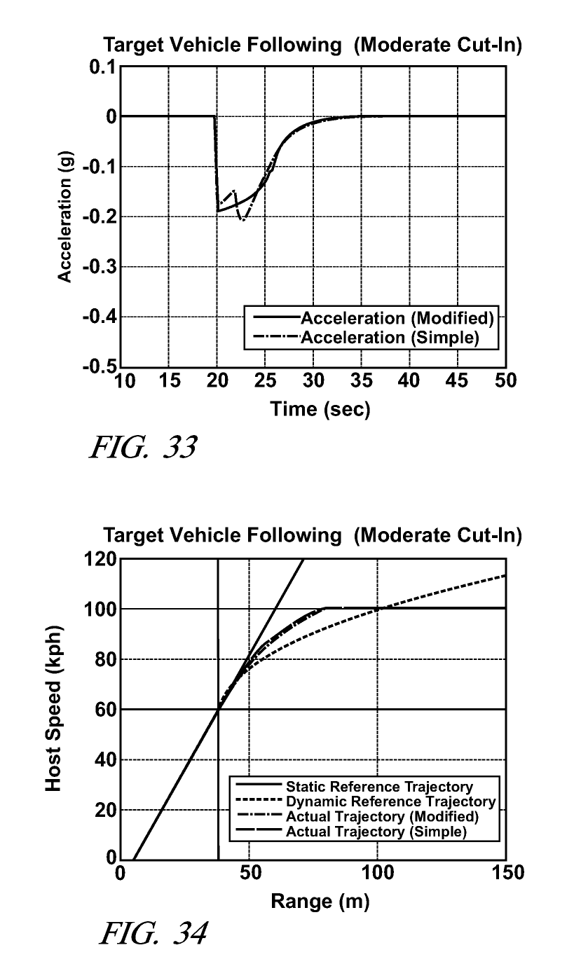

FIGS. 31-34 show simulation results for the moderate cut-in simulation. As shown in FIG. 31, the host vehicle starts reducing its speed when the target vehicle cuts in. In this case, both simple and modified sliding mode control show the similar transient behavior. FIG. 33 shows the applied brake during the speed transition. Since the speed difference between the two vehicles is large for the initial range, host vehicle applies significantly large amount of initial braking and applies less braking as the host vehicle reduces its speed. In this case both simple and modified sliding mode controls similar braking profile. FIG. 34 shows the speed-range trajectory. As shown in the plot, the initial state of the speed and range is off the reference trajectory (sliding surface). The control algorithm first tries to bring the actual state trajectory to the reference trajectory. Once the actual trajectory approaches the reference trajectory, the actual trajectory approaches the equilibrium state (16.11 m at 20 kph) along the reference trajectory.

Another scenario is simulated to adjust the speed and range in an aggressive cut-in situation. Initially, the host vehicle speed is set to 100 kph. At about 22 seconds, a target vehicle enters in to the host vehicle lane with the speed of 60 kph and range of 40 m.

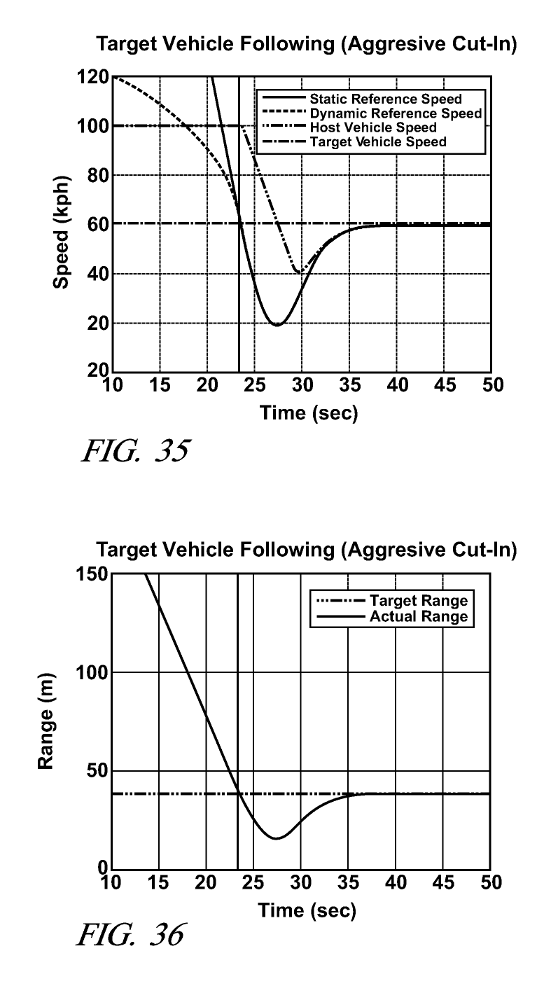

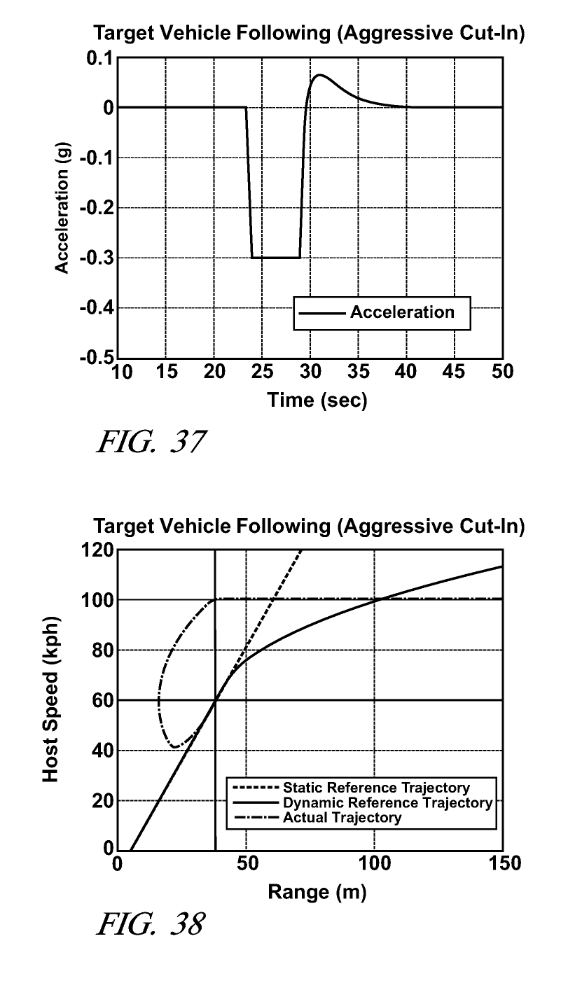

FIGS. 35-38 show the simulation results. In this situation, dynamic profile of reference speed does not play a role. Therefore, the simple and modified sliding mode controls do not make any difference. It is more convenient to explain the transient response in terms of state trajectory shown in FIG. 38. Once the target vehicle cuts in, initial state is far off the reference trajectory and the controller first tries to bring the state close to the reference trajectory by reducing the host vehicle speed. Even during the initial braking, the host vehicle is still faster than the target vehicle, and the range decreases down to 20 m. Once the host vehicle speed is less than the target speed, the range starts increasing. When a safe range is acquired, the host vehicle accelerates to catch up the speed and range along the reference trajectory. FIGS. 35, 36, and 37 show the corresponding speed, range, and acceleration, respectively.

A final scenario was simulated to show the response of the host vehicle when the target vehicle suddenly stops. Initially, the host vehicle speed is following the target vehicle at 100 kph. Then target vehicle suddenly decelerates at 0.3 g down to full stop. The host vehicle applies brake and stops 5 m behind the target vehicle, where 5 m is the zero speed distance.

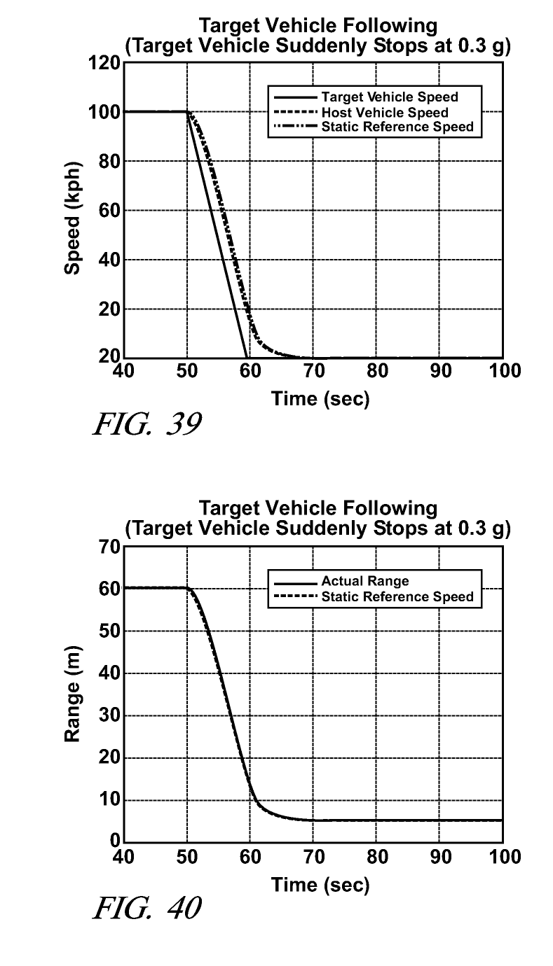

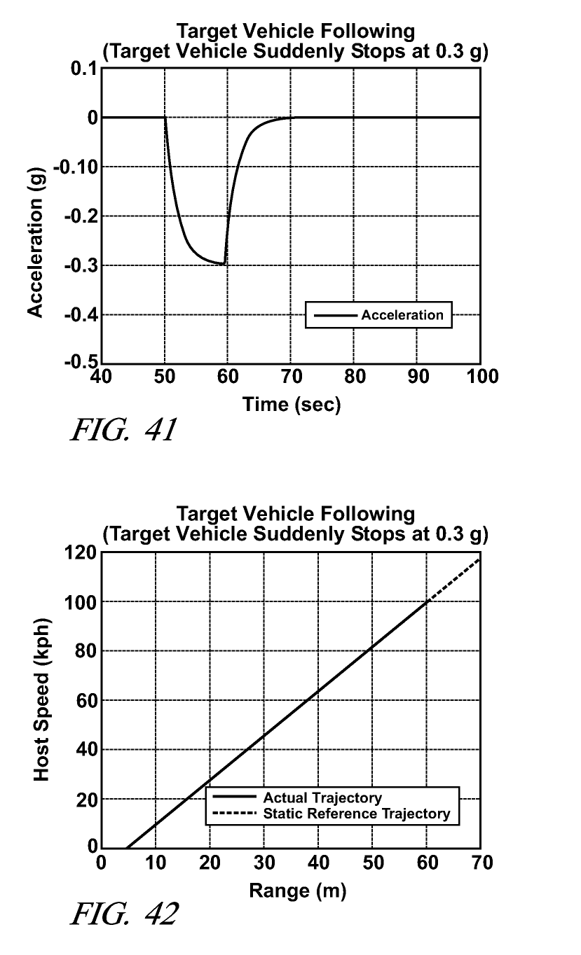

In this scenario, the dynamic profile of reference speed does not play a role, and the simple and the modified sliding mode control behaves the same. This scenario is to show that the speed-range trajectory remains on the static sliding surface once it is on the same surface. Initially, the host vehicle speed is following the target vehicle at 100 kph. The, target vehicle suddenly decelerates at 0.3 g down to full stop. The host vehicle applies brake and stops 5 m behind the target vehicle, where 5 m is the zero speed distance. FIGS. 39-42 graphically depict the results of the sudden stop simulation.

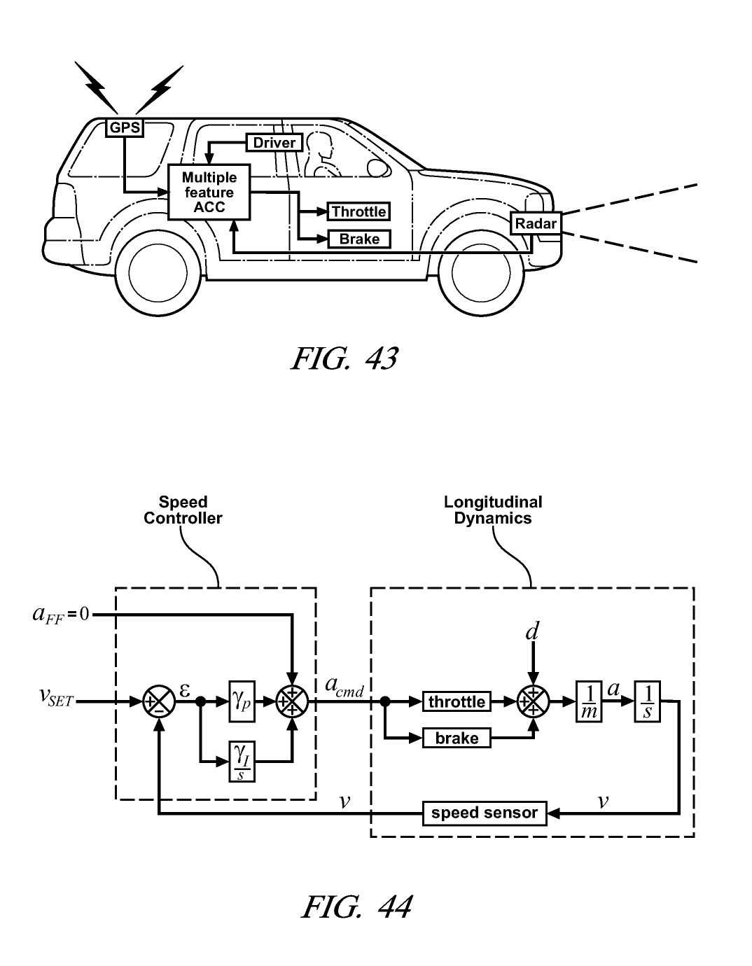

FIG. 43 schematically illustrates an exemplary vehicle equipped with a multiple feature ACC control, in accordance with the present disclosure. As described above, a multiple feature ACC control can be utilized to monitor inputs from various sources, including sensors disposed on any and all portions of the vehicle, prioritize control of vehicle speed based upon the various inputs, and output speed and acceleration control commands to a vehicle speed control system.

Multiple feature ACC is an autonomous and convenience feature that extends the conventional ACC by integrating multiple features including conventional cruise control, ACC, speed-limit following, and curve speed control.

Conventional cruise control maintains vehicle speed at the driver-selected reference or set speed v_{SET}, if there is no preceding vehicle or curve or speed-limit change. The monitored input to the conventional cruise control is vehicle speed. The speed controller calculates necessary acceleration command a_{cmd}. If the acceleration command is positive, throttle is applied, and if the acceleration command is negative, brake is applied.

FIG. 44 schematically illustrates operation of an exemplary conventional cruise control system, in accordance with the present disclosure. The set speed or v_{SET} is monitored, a_{FF} representing acceleration input outside of the cruise control is kept to zero, and resulting speed in the vehicle or v is monitored as a feedback term. A command, a_{cmd}, is output to a vehicle speed control system in the form of a throttle control module and a brake control module. In this way, a system can track a set speed and control vehicle speed to match the set speed.

A system equipped with ACC maintains driver-selected headway distance if a preceding vehicle is detected by forward looking sensors such as radar. ACC also extends the ACC functionality in the low speed range.

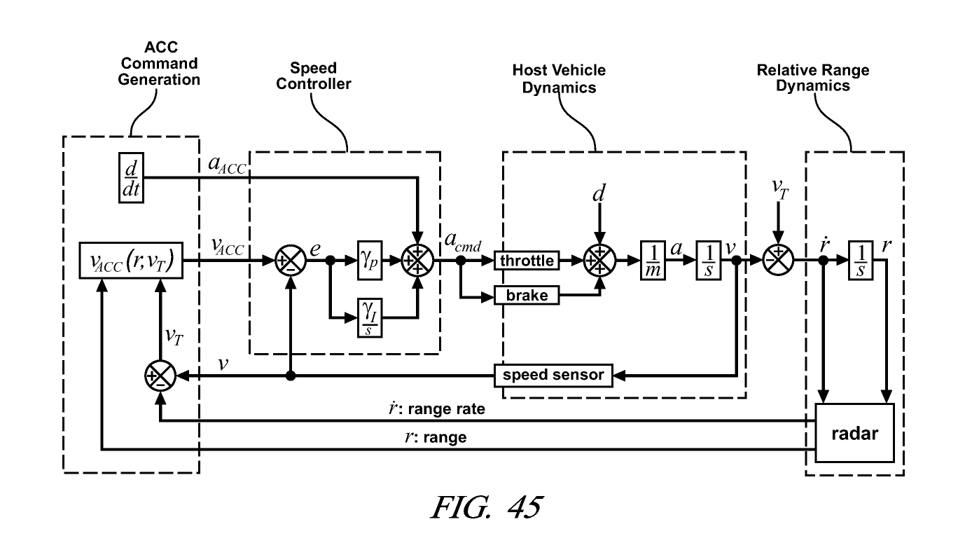

FIG. 45 schematically illustrates operation of an exemplary conventional cruise control system, in accordance with the present disclosure. The monitored inputs are vehicle speed, range and range rate. The ACC Command Generation block generates desired speed v_{ACC} and desired acceleration a_{ACC}. The speed controller calculates necessary acceleration command a_{cmd} as an output, and outputs the command to a vehicle speed control system. If the acceleration command is positive, throttle is applied, and if the acceleration command is negative, brake is applied.

Speed limit following (SLF) automatically changes the set speed in response to detected changes in the legal speed limit. In one exemplary embodiment, a system equipped with SLF reduces vehicle speed before entering into a lower speed-limit zone and accelerates after entering the higher speed-limit zone. In an exemplary system, a GPS system detects a current location for the vehicle. A map database provides the speed limit of current location, location of next speed limit changing point and its distance from the current location, and the next speed limit. By coordinating location and speed limit data, a dynamic set speed can be utilized to automatically control the vehicle speed to a prescribed limit.

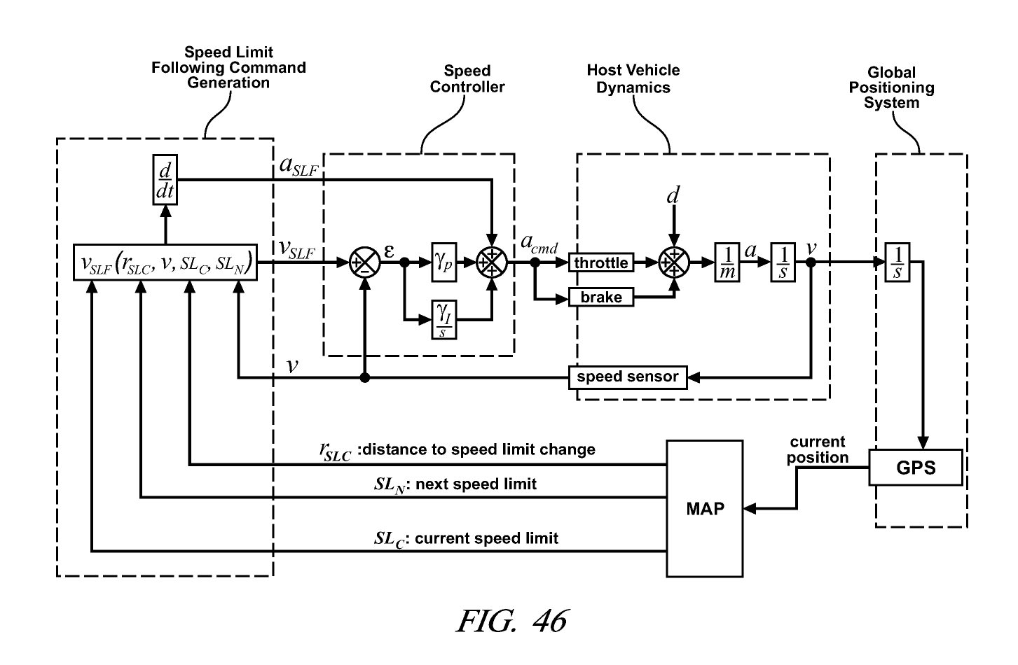

FIG. 46 schematically illustrates operation of an exemplary speed limit following control system, in accordance with the present disclosure. The speed limit following command generation block inputs vehicle speed, distance to the next speed limit change, next speed limit, and current speed limit. The outputs of speed limit following command generation block are desired speed v_{SLF} and desired acceleration a_{SLF}. The speed controller calculates necessary acceleration command a_{cmd} as an output, and outputs the command to a vehicle speed control system. If the acceleration command is positive, throttle is applied, and if the acceleration command is negative, brake is applied.

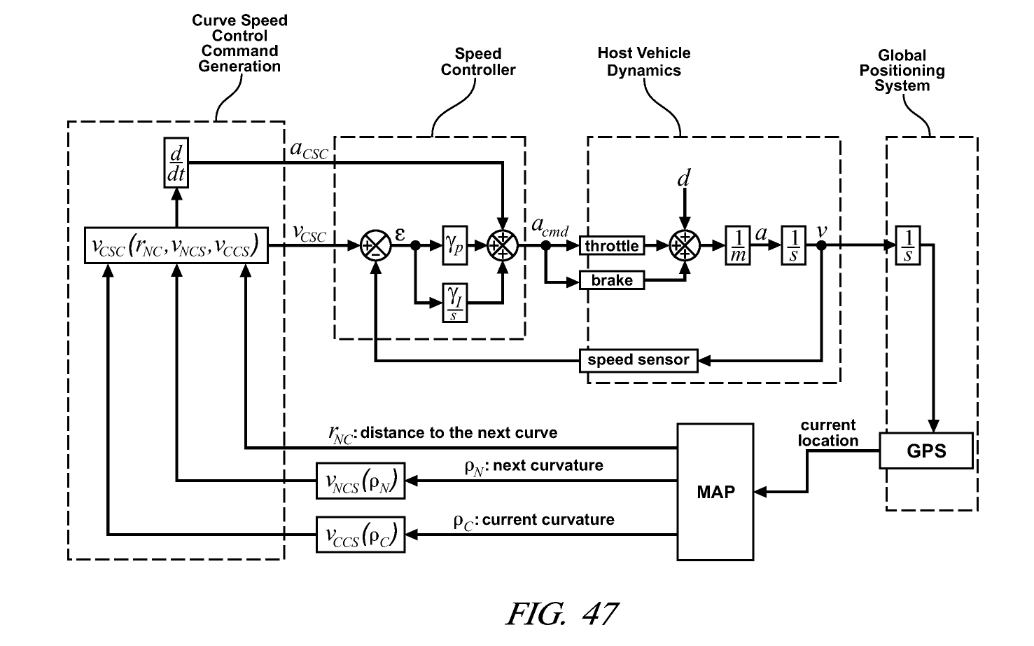

Curve Speed Control reduces vehicle speed accordingly at a curve or before entering a curve if vehicle speed is faster than a safe turning speed. FIG. 47 schematically illustrates operation of an exemplary speed limit following control system, in accordance with the present disclosure. The GPS system detects current location and the speed limit of current location. The MAP database provides the curvature of current location ρ_{C}, location of next curvature change and its distance from the current location r_{NC}, and the next curvature ρ_{N}. The curvatures are converted into curve speeds by look-up tables v_{NCS}(ρ_{N}) and v_{CCS}(ρ_{C}). The speed curve speed control command generation block inputs vehicle speed, distance to the next curvature change, next curve speed, and current curve speed. The outputs of curve speed control command generation block are desired speed v_{CSC} and desired acceleration a_{CSC}. The speed controller calculates necessary acceleration command a_{cmd}, and outputs the command to a vehicle speed control system. If the acceleration command is positive, throttle is applied, and if the acceleration command is negative, brake is applied.

The various features of a multiple feature ACC are controlled with a common controller, utilizing a command arbitration function to select between the various outputs of each of the features to control the vehicle. The multiple features can be combined by sharing the same speed controller but different command generation blocks. Each command generation blocks outputs desired acceleration and desired speed. The command arbitration block compares desired accelerations and speeds from multiple command generations blocks and determines arbitrated acceleration and speed.

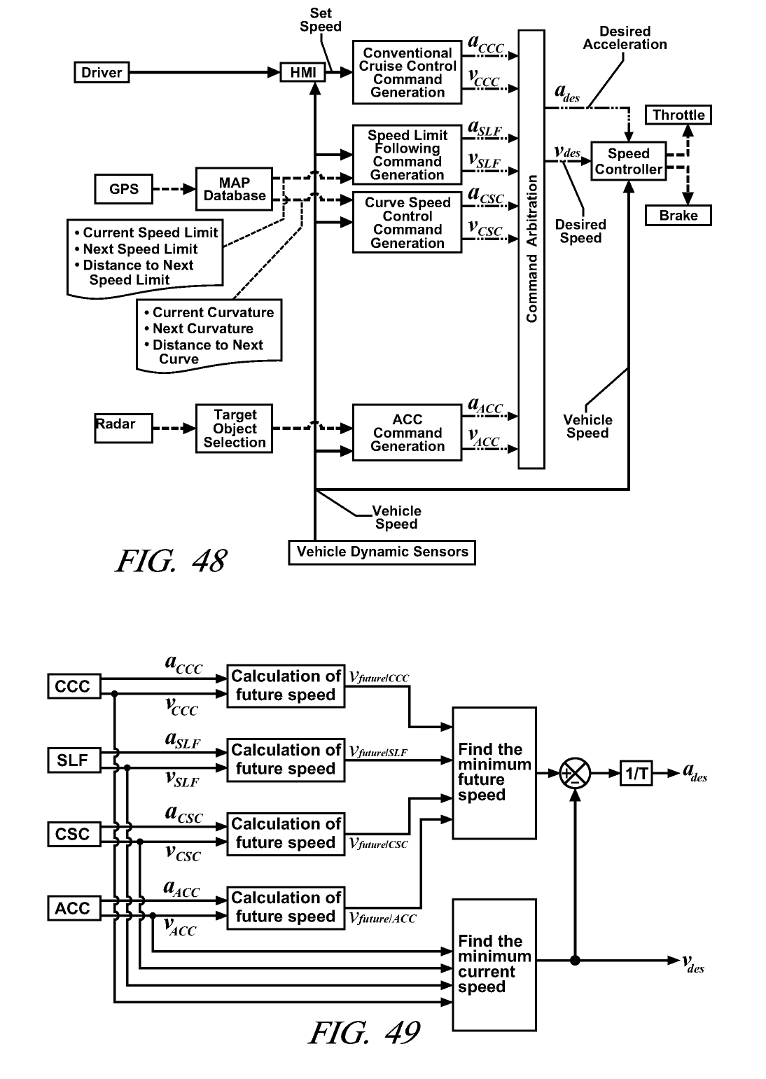

FIG. 48 schematically illustrates an exemplary control system, including a command arbitration function, monitoring various inputs and creating a single velocity output and a single acceleration output for use by a single vehicle speed controller, in accordance with the present disclosure. Each of the features operates as described above, and outputs from these features are monitored and prioritized in the command arbitration block. The various features can target different speeds and different accelerations, but the limits of each feature must be obeyed. For instance, the ACC feature may request an acceleration due to an increasing range to the target vehicle in front of the host vehicle, but the speed limit following feature may restrict such an acceleration due to the vehicle approaching a transition to a lower speed limit. Even where no current limit prohibits fulfilling a speed or acceleration request from one of the features, an upcoming change in conditions can make pending requests adverse to maintaining drivability. A method to achieve command arbitration between various outputs of a multiple feature ACC system can include predicting speeds desired by each feature at some future time and comparing these predicted speeds. This comparison allows the system to select the lowest predicted desired speed at the future time and thereby avoid violating this lowest predicted desired speed or creating adverse drivability conditions based upon abrupt changes in a_{cmd}.

FIG. 49 illustrates an exemplary data flow predicting future speeds required by various speed control methods and utilizing a command arbitration function to select a method based upon the arbitration, in accordance with the present disclosure. Various ACC features are depicted, including velocity and acceleration outputs. Each of these outputs is input to a calculation block predicting a predicted v_{future} for each feature. These predicted terms are then selected from to find a minimum desired future speed, and this term is used in the control of the vehicle.

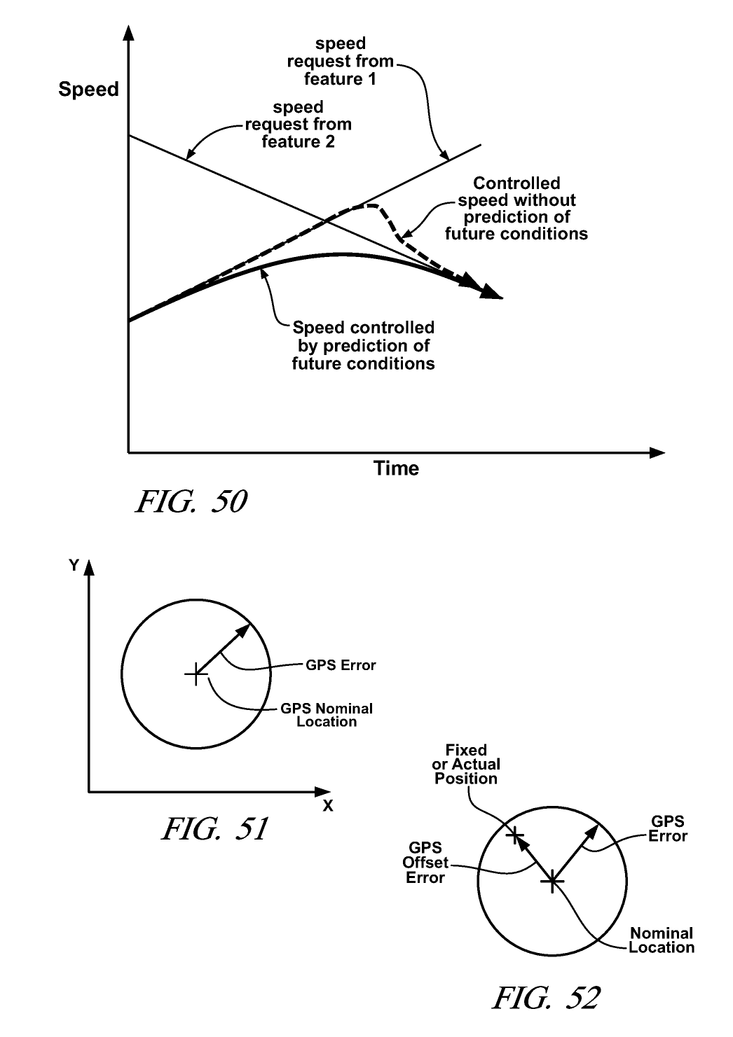

FIG. 50 graphically illustrates exemplary reaction times of a vehicle to changes in desired speeds of various ACC features, including an exemplary prediction of desired future speed, in accordance with the present disclosure. At the left side of the graph, the system begins with a speed request from a feature 1 dominating the controlled speed. In a system wherein no prediction of future conditions or no prediction of desired speeds of the various features is performed, the system controls speed according to the feature 1 limit until the speed request from feature 2 becomes less than the speed request from feature 1. At this point, the system experiences a reaction time, in terms of sensor reaction time, computational reaction time, and powertrain and brake reaction times to the changing input. Speed is then changed in order to quickly match the new limit placed by feature 2. However, as will be appreciated by one having ordinary skill in the art, reaction time in a vehicle to an abrupt change in inputs necessarily involves a perceptible transition time. If instead, the speed of the vehicle is controlled by prediction of future conditions or prediction of desired speeds of the various features, then speed of the vehicle can be controlled more smoothly, avoiding violation of desired speeds caused by reaction times in the system to current outputs of the various features.

Command arbitration can be further explained by taking minimum speed and/or acceleration from different features. Feature x generates two commands v_{X} and a_{X}, wherein v_{X} and a_{X} are current desired speed and current desired acceleration, respectively. Therefore we can extrapolate future desired speed v_{future/X} from v_{X} and a_{X}. By assigning a time horizon T, the desired future speed is calculated as follows.

v_{future/X}=v_{X}+a_{X}·T [32]

Therefore command arbitration is achieved by taking minimum future desired speed from multiple requests.

An exemplary command arbitration process can be illustrated as follows.

| | |
|---|---|
| Parameter: T; | |
| Inputs: v_{CCC}, v_{SLF}, v_{CSC}, v_{ACC}, a_{CCC}, a_{SLF}, a_{CSC}, a_{ACC}; | |
| Calculate Future Reference Speeds: | |
| v_{future/CCC} = v_{CCC} + a_{CCC} · T | [33] |
| (CCC = Conventional Cruise Control) | |
| v_{future/SLF} = v_{SLF} + a_{SLF} · T | [34] |
| (SLF = Speed Limit Following) | |
| v_{future/CSC} = v_{CSC} + a_{CSC} · T | [35] |
| (CSC = Curve Speed Control) | |
| v_{future/ACC} = v_{ACC} + a_{ACC} · T | [36] |
| (ACC = Adaptive Cruise Control) | |
| Find Minimum Future Reference Speed: | |
| v_{future} = min(v_{future/CCC}, v_{future/SLF}, v_{future/CSC}, | [37] |
| v_{future/ACC}) | |
| Find Minimum Current Reference Speed: | |
| v_{current} = min(v_{CCC}, v_{SLF}, v_{CSC}, v_{ACC}) | [38] |
| Select Reference Speed and Reference Acceleration: | |
| v_{ref} = v_{current} | [39] |
| ${a}_{ref} = \frac{{v}_{future} - {v}_{current}}{T}$ | [40] |
| Outputs: v_{ref}, a_{ref} | |

The exemplary ACC system is depicted above with a conventional cruise control feature, an adaptive cruise control feature, a speed limit following feature, and a curve speed control feature. However, it will be appreciated that the methods described herein can be used with any sub-combination of these features, for example, a system with only conventional cruise control and curve speed control features. In addition, other modules controlling speed to other factors, including weather, traffic, identified road hazards, identified pollution control zones, hybrid drive control strategies (for instance optimizing energy recovery through speed modulation), or any other such features, can be utilized in accordance with the above methodology, and the disclosure is not intended to be limited thereto.

The interval of prediction or time horizon T can be selected according to any method sufficient to predict control, braking, and powertrain reaction times to inputs. As described above, T should be long enough to prevent the vehicle speed from overshooting a change in a minimum desired speed. Further, it will be appreciated that a longer analysis of changes in desired speed can be achieved, preventing numerous iterative changes in vehicle speed or smoothing between numerous changes in vehicle speed by extending T in order to predict operation of the vehicle further into the future. In the alternative, T can be retained as a relatively short time value, based primarily on vehicle reaction times, and a secondary operation can be performed according to methods known in the art to preserve drivability between subsequent vehicle speed changes by smoothing between iterative foreseeable changes as described above.

Sensor data and other information can be used in various applications to implement autonomous or semi-autonomous control a vehicle. For example, ACC is known wherein a vehicle monitors a range to a target vehicle and controls vehicle speed in order to maintain a minimum range to the target vehicle. Lane keeping methods utilize available information to predict and respond to a vehicle unexpectedly crossing a lane boundary. Object tracking methods monitor objects in the operating environment of the vehicle and facilitate reactions to the object tracks. Lateral vehicle control is known wherein information related to a projected clear path, lane keeping boundary, or potential for collision is utilized to steer the vehicle. Lateral vehicle control can be used to implement lane changes, and sensor data can be used to check the lane change for availability. Collision avoidance systems or collision preparation systems are known, wherein information is monitored and utilized to predict a likelihood of collision. Actions are taken in the event the predicted likelihood of collision exceeds a threshold. Many forms of autonomous and semi-autonomous control are known, and the disclosure is not intended to be limited to the particular exemplary embodiments described herein.

FIG. 51 depicts an exemplary GPS coordinate that is monitored by a GPS device. A GPS device returns information from a remote satellite system describing a location of the GPS device according to a global coordinate system (latitude, longitude, altitude). The information returned can be described as a nominal location. However, as described above, GPS data is not precise and includes a GPS error. The actual location of the GPS device can be anywhere within an area defined by the nominal location and the GPS error. When calculating distance between vehicles using GPS position differencing, most GPS errors will cancel out for vehicles in close neighborhood (e.g., within 500 m) and accurate relative distances can often be obtained.

FIG. 52 depicts information from a GPS device, including a nominal position, a GPS error margin, and a determined actual position defining a GPS offset error, in accordance with the present disclosure. As described above, a nominal position is monitored through a GPS device. Based upon error inherent in GPS technology, some inaccuracy in the GPS determination is inherent to the nominal location, creating a range of possible positions in relation to the nominal position. By methods such as the exemplary methods described above, an actual or fixed location of the GPS device can be determined By comparing the actual or fixed location of the GPS device to the nominal position, a GPS offset error can be calculated as a vector offset from the nominal position.

Errors in sensing devices can be randomly offset in changing directions and distances, with scattered results indicating poor precision; or errors can be consistently offset in a particular direction and distance, with tightly grouped results indicating good precision. One having ordinary skill in the art of GPS devices will appreciate that error in a GPS device tends to exhibit good precision, with iterative results in an area and in close time intervals exhibiting closely grouped results with similar GPS error offsets. Similarly, multiple devices operating in a close proximity to each other and monitoring nominal position information at substantially the same time tend to experience similar GPS error offsets.

One having ordinary skill in the art appreciates that a number of methods are known to fix or triangulate the position of a vehicle. For example, radar returns or radio returns from two known objects can be used to triangulate position of a vehicle on a map. Once a position is fixed at some instant in time, another method could determine an estimated change in position of the vehicle by estimating motion of the vehicle, for example, assuming travel along a present road based upon a monitored vehicle speed, through use of a gyroscopic or accelerometer device, or based upon determining a GPS error margin by comparing the last fixed location to the GPS nominal position at that instant and assuming the GPS error margin to be similar for some period. One having ordinary skill in the art will appreciate that many such exemplary methods are known, and the disclosure is not intended to be limited to the exemplary methods described herein. Further, an exemplary infrastructure device is disclosed, a GPS differential device, that can be located along roads, communicate with passing vehicles, and provide a GPS offset value to the vehicles for a localized area. In such a known device, a GPS nominal location for the device is compared to a fixed, known position for the device, and the difference yields a GPS offset value that can be utilized by vehicles operating in the area. Through use of such a device, sensor readings and calculations to triangulate a location of a host vehicle are unnecessary.

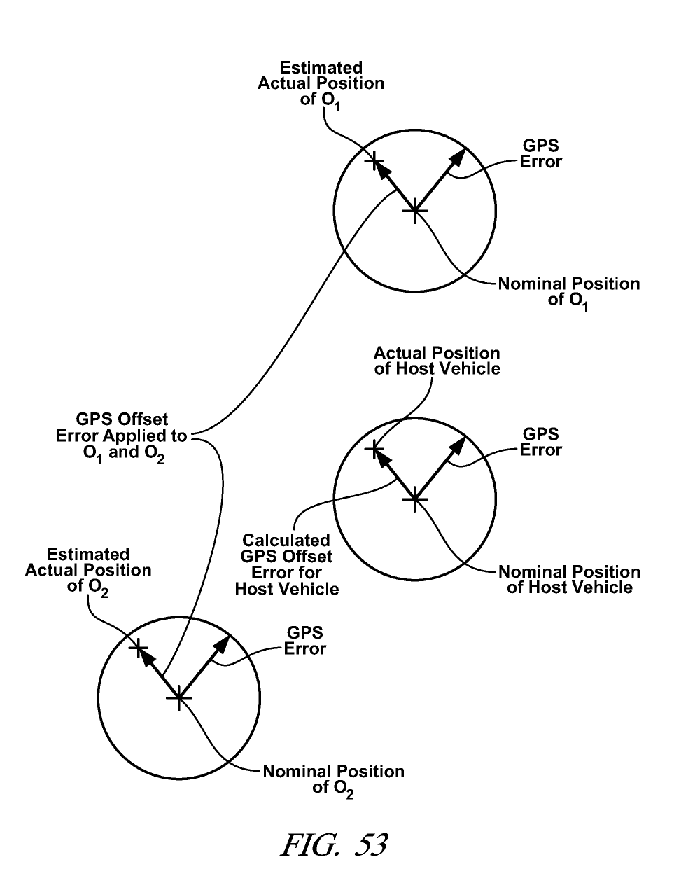

FIG. 53 depicts a host vehicle and two target objects, all monitoring GPS nominal positions, and resulting GPS offset errors, in accordance with embodiments of the present disclosure.

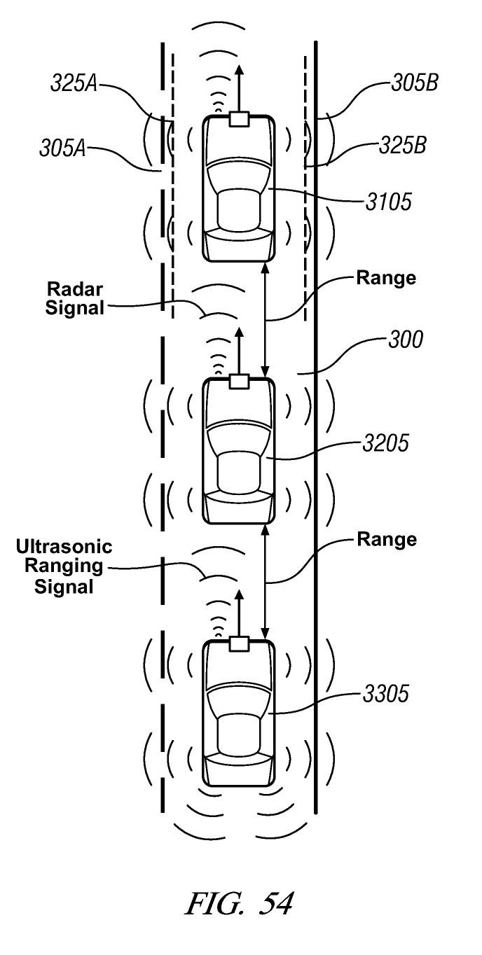

Methods are known to utilize information regarding the driving environment around a vehicle to control autonomously or semi-autonomously the relative location of the vehicle with respect to a lane and with respect to other vehicles. FIG. 54 depicts vehicles utilizing exemplary methods to control vehicle operation, in accordance with the present disclosure. Vehicle 3105, vehicle 3205, and vehicle 3305 are traveling in lane 300 defined by lane markers 305A and 305B. Vehicle 3205 is utilizing a radar signal to determine a range to vehicle 3105, useful, for example, in an ACC application, and vehicle 3205 is additionally utilizing known methods to establish an estimated position within the lane and determine lane keeping boundaries 325A and 325B. Vehicle 3305 is similarly monitoring a range to vehicle 3205, in this exemplary case, through use of an ultrasonic signal. Vehicle 3305 can be operated manually, for example, with the operator steering the vehicle and utilizing range information to maintain a desirable following distance behind vehicle 3205.

As described above, GPS offset errors in multiple objects monitoring nominal positions at the same time tend to exhibit the same or similar GPS offset errors. Nominal positions for the host vehicle and for target objects O₁ and O₂ are described, for example, describing each of the nominal positions as if three GPS devices were present, one in the host vehicle and one in each of the target objects. An actual position of the host vehicle is determined, and a GPS offset error can be determined for the host vehicle. Based upon the tendency of GPS devices to provide information with good precision and based upon an accurate estimation of the actual location of the host vehicle, correlation of the three nominal locations provides an ability to determine indicated actual positions for O₁ and O₂ with high accuracy.

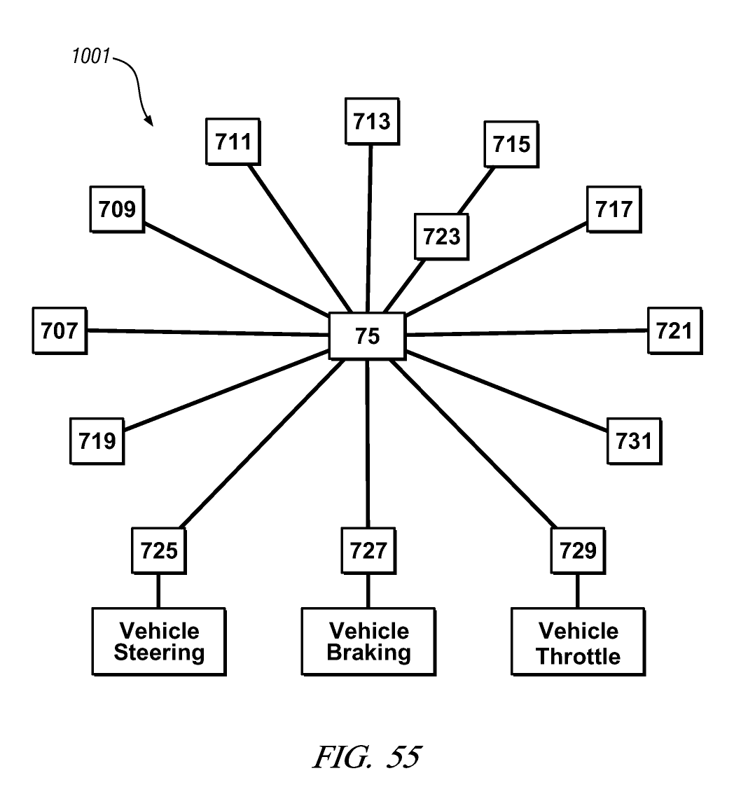

FIG. 55 shows a schematic view of a system 1001 provided by one embodiment of the disclosure. There is a controller 75, which includes a microprocessor having memory operatively connected thereto and which is configured to receive input data and provide output commands responsive thereto, effective for controlling travel characteristics of a motorized vehicle.

In preferred embodiments, input data for the controller 75 is provided by at least one positional information device. In some embodiments, one type of positional information device as shown and described is employed, while in other embodiments any combination of two or more types of positional information devices selected from the group consisting of: ultrasonic sensors 707, light detection and ranging (LIDAR) sensors 709, optical sensors 711, radar-based sensors 713, global positioning system (GPS) sensors 715, and optional V2V communications interfaces 717 are provided to provide inputs to the controller 75. In some embodiments, traffic information and position using triangulation, telemetry, or other known means is uploaded to the vehicle to be accessible to the vehicle's processor for use in vehicle position control. In some embodiments, a plurality of a single type of positional information device is employed, while in other embodiments a plurality of positional information devices of more than one single type are employed. Such positional information devices and hardware associated with their use in providing positional information are generally known in the art.

Thus, a motorized vehicle employing a system as herein provided will typically have object detection sensors disposed along its perimeter, utilizing one or more of ultrasonic, LIDAR-based, vision-based (optical) and radar-based technologies. Among these technologies, short range radars are preferable due to their ease in deployment about the perimeter of a vehicle and high-quality object detection characteristics, which are less susceptible to changes in the operating environment than other sensing means. These radars have wide horizontal field of view, can detect object's range down to very short distances with reasonable maximum range, can directly measure closing or opening velocities, and resolve the position of an object within its field of view. Ultrasonic sensors, which are often provided on the front and rear portions of vehicles are useful to indicate the presence of objects with their ranges in those regions. Optical sensors including cameras with image processing capabilities classify objects about the vehicle and provide information such as basic discrimination concerning other vehicles, pedestrians, road signs, barriers, overpasses, and the like. Image processing is also useful for providing range and range rate information. LIDAR is also useful for providing range and angular positional information on various objects.

Travel characteristics of a motorized vehicle, including without limitation automobiles and trucks, are influenced by vehicle operational parameters which include one or more of vehicle velocity, vehicle acceleration and the direction of vehicle travel. Changes or maintenance of vehicle velocity and acceleration are readily achieved by controlling or altering engine speed, transmission gear selection and braking, and direction of vehicle travel is readily maintained or altered by controlling the steering of the vehicle's wheels. Controls for effecting changes in the aforesaid operational parameters electronically are known in the art and include various servo-operated electromechanical devices, such as cruise control and related hardware and software, and calibrated servo motors with associated positional sensing equipment. Thus, in preferred embodiments there is an electronically-actuated steering control device 725 operatively connected to the output of the controller 75 that is configured to effectuate changes or maintenance of vehicle steering responsive to output commands from the controller 75. In preferred embodiments, there is an electronically-actuated braking control device 727 operatively connected to the output of the controller 75 that is configured to effectuate application of vehicle braking responsive to output commands from the controller 75. In preferred embodiments there is an electronically-actuated throttle control device 729 operatively connected to the output of the controller 75 that is configured to effectuate changes or maintenance of vehicle engine speed responsive to output commands from the controller 75. As used herein, “throttle” refers to a control for the speed of an engine, and includes rheostats and other devices used for controlling the speed of a motor or engine which is the primary means of propulsion for a motorized vehicle.

Generally speaking, use of a system as provided herein causes a motorized vehicle to automatically remain on the road during a period of its travel, without any interaction from a person aboard the vehicle, including driver-commanded steering, braking and acceleration. One aspect for achieving such function is through the generation of an updatable map database, such as by use of differential GPS (including that provided by General Motors Corporation under its trademark ONSTAR®), which map database may be readily stored in computer memory on-board the motorized vehicle. The position of the vehicle being controlled on the map database is at all times monitored and its travel characteristics are selectively altered responsive to changes in features present on the map database and features derived in real time from on-board sensors. These features include without limitation fixed roadway infrastructure, including bridges, embankments, and other engineered structures, as well as objects on or adjacent to the roadway itself, including road debris, construction navigational aids such as orange barrels, signposts, and other motorized vehicles on the roadway.

A system according to the disclosure includes driver-actuable control for activating the system, and driver-actuable and automatic control for de-activating the system. In one embodiment, the motorized vehicle's rider compartment includes an on/off switch for the system, which is manually actuable. Once activated, a system according to the disclosure may be de-activated by the on/off switch, which may include a touch-activated switch that de-activates the system when a person touches the vehicle's steering wheel. In a preferred embodiment the system is automatically de-activated for instances in which communication between the vehicle and the GPS system is broken by a de-activation relay 723, with an audible and/or visual warning provided to the operator of the vehicle. For this, signal-sensing means known in the art capable of opening or closing a circuit in response to loss of an RF signal may be suitably employed. In alternate embodiments in which a V2V communications interface is employed as an input to the controller 75, the system is de-activated upon loss of communication with other vehicles in the vicinity of the motorized vehicle which are similarly equipped with V2V communications interfaces.

Motorized vehicles equipped with V2V communications interfaces enable the vehicles to communicate with one another, and such communications can include the transmission of information concerning objects present in the vicinity of each of such vehicles, including the position of other vehicles on the roadway and whether such vehicles themselves are braking, accelerating, or changing their travel direction. Combining such information with that provided by on-board sensors previously mentioned provides the controller 75 with sufficient information for generation of a plan view of the roadway, the position of motorized vehicle and the objects around it on the roadway, and the velocities of each sufficiently to permit automatic effectuation of changes in operating parameters of the vehicle for avoidance of collision with such objects.

The controller 75 controls the steering to keep the vehicle within a lane on the roadway without colliding with objects intruding in its path, the steering being accomplished by precise and responsive steer-by-wire technology. The controller 75 controls the throttle and brakes to smoothly propel the vehicle within its lane using electronic throttle control and brake-by-wire. The vehicle accelerates, decelerates or cruises smoothly without colliding with any vehicle or object, mimicking an ideal driver's behavior. Using the production vehicle dynamic sensors, the controller 75 will predict the path of the vehicle and will correct the path via closed-loop control to match an intended path generated by the processing unit. The controller 75 calculates time-to-collision of each and every object around the vehicle and adjusts the vehicle's operational parameters to navigate safely without any collisions. In one embodiment, the preferred operational envelope of a system as provided herein is limited to a vehicle traveling in the forward direction only at relatively low speeds, such as during grid-lock conditions on a highway when vehicle speeds do not generally exceed about 40 miles per hour, the performance of object detections sensors, computing platforms and actuators known in the art are sufficient for such accomplishment.

In some embodiments a system as provided herein is particularly useful during driving conditions known as grid-lock, which occurs when highways are crowded with vehicles, such as during “rush-hour” traffic times. It is typical in grid-lock conditions for vehicles to not be traveling in excess of about 40 miles per hour. During grid-lock, the driver of a vehicle equipped with a system as provided herein pushes a button to activate the system. The information provided as inputs to the controller 75 is gathered and the vehicle is automatically navigated autonomously without any intervention of the driver.

There are various thresholds associated with operation of a system as provided herein, including thresholds at which commands for alteration or maintenance of braking, acceleration, and steering of the vehicle are to be effected. These thresholds are adjustable via programming in the software used in the controller 75. In one embodiment, a braking command is caused when the traveling vehicle approaches another object that is distanced from the vehicle by 10 meters at a rate exceeding 3 meters per second. In another embodiment, a braking command is caused when the traveling vehicle approaches another object that is distanced from the vehicle by 10 meters at a rate exceeding 4 meters per second. In another embodiment, a steering command is caused when the traveling vehicle approaches another object that is distanced from the vehicle by 10 meters at a rate exceeding 3 meters per second and there is sufficient space for an evasive steering action to avoid the object. In another embodiment, an acceleration command is caused when the traveling vehicle lags behind another object that is distanced from the vehicle by 10 meters at a rate exceeding 3 meters per second. These aforesaid rates and distances, and the amounts at rates of application of braking, acceleration and steering are readily adjustable by vehicle engineers as deemed either necessary or desirable for a given vehicle configuration. It is preferable in some embodiments that when braking or steering commands are issued, these are accompanied by a simultaneous closing of the engine's throttle.

In one embodiment a system as provided herein includes an alarm 731, which alarm is selected from the group consisting of: audible alarms and visual alarms, and the controller 75 is configured to activate at least one such alarm to alert a vehicle occupant upon loss of communication between the microprocessor and at least one of the positional information devices present.

In another embodiment, a system as provided is configured to trigger an alarm when any condition or event is present or has occurred that affects the integrity of the system to perform its function of operating a motorized vehicle without an operator needing to provide manual inputs for steering, braking or vehicle acceleration. These conditions or events may be specified in software by vehicle engineers, depending on intended service of the motorized vehicle and include such events as electrical system failures, engine failure, braking system failure, steering system failure, ambient weather conditions, headlamp failure, roadway conditions including traffic density, extravehicular object proximity, road condition, extravehicular traffic proximity forcing the vehicle out of lane, loss of lane identification and speed in excess of a pre-determined minimum. In some embodiments, a system as provided is configured to issue a statement to a vehicle occupant that they must take over control of the vehicle, responsive to the presence of one or more of the aforesaid conditions. In some embodiments, the system remains engaged to avoid collisions and the driver/vehicle occupants are warned if the vehicle speed approaches a pre-determined maximum, when the frequency of extravehicular objects within a pre-determined threshold proximity is excessively high for continued safe autonomous driving, when conditions are present that make lane identification or traffic proximity detection difficult or impossible to resolve, and when a vehicle system as herein provided determines that in order to maintain relative position in traffic the vehicle must deviate from its prescribed lane.

In some embodiments, operation of a motorized vehicle according to the disclosure explicitly relies on sensing proximity to other vehicle traffic in the vicinity of the vehicle for its autonomous driving that includes full driver disengagement of the steering mechanism to provide “hands off the wheel” operation at relatively low vehicle speeds pre-determined by vehicle engineers, for specific circumstances including “grid-lock” traffic conditions in which proximity sensing of surrounding traffic and other objects is facile. In some embodiments, operation as provided herein differs from other autonomous driving known or described herein, in that lane recognition is employed for error sensing, instead of directing vehicle travel. In such embodiments, this is the general opposite of driving models employed at relatively higher vehicle velocities that employ lane-sensing/recognition for drive directing and proximity sensing for error detection.

In yet another embodiment, a system as provided is configured to cause the vehicle to navigate itself to the shoulder of the roadway, and optionally automatically placing an emergency call through a communications system such as that provided by the General Motors Corporation under the ONSTAR® trademark or substantially equivalent communications.

Methods are described herein to employ a grid unlock mode, wherein a vehicle autonomously operates in a congested traffic condition without direct input from the driver. Once conditions required to enable the grid unlock mode are met, for example, including low speed operation, for example, less than a threshold grid-lock speed, with a target vehicle being tracked prohibiting free acceleration of the vehicle, an option to enter the grid unlock mode can be presented to the driver for selection.

Once the grid unlock mode is activated, the vehicle is controlled to operate on the roadway. This operation on the roadway can be simply to travel along the present lane until the driver intervenes or overrides the control. In the alternative, the vehicle can be enabled through methods described above to change lanes of travel depending upon sensed traffic and other obstructions on the roadway. Travel can be limited to highway travel whereupon interaction with traffic signals is limited or non-existent. In other embodiments, camera devices coupled with pattern recognition software can be utilized to evaluate traffic signals and control operation of the vehicle appropriately. Traffic signals can include but are not limited to stop lights, stop signs, speed limit signs, school zone signs, emergency vehicle indications, railroad crossing indications, required lane change indications, construction traffic indications or barriers, and yield signs. Such interaction with traffic signals can be accomplished alternatively or complimentarily with V2V or vehicle to infrastructure (V2I) communications. V2V and V2I information can be used to describe current conditions, for example in an intersection. Such communications can additionally be used to forecast likely conditions in the intersection, for example, 15 seconds in advance, allowing preparing in the grid unlock activated vehicle actions to stop or proceed through the intersection.

Operation of the grid unlock mode can be ended or terminated by the occurrence of a number of actions or conditions. A driver can at any time activate a driver control and overall part or all of the grid unlock mode. The level of deactivation can be preset or selectable within the vehicle. For example, a driver could briefly activate a brake to slow the vehicle, but the grid unlock mode could remain active based upon the brevity of the driver input, retaining steering control and slowly recovering speed control after the driver intervention ceases. Similarly, a driver could access the steering wheel and the accelerator to execute a manual lane change. Upon completion of the lane change, the driver could release the steering wheel and accelerator, and the vehicle could resume the grid unlock mode in the new lane of travel. Resumption of the grid unlock mode could be assumed to be proper under such circumstances or an option could be presented to the operator, for example, prompting a button push or a verbal response to resume the grid unlock mode.

Another example of a condition to terminate the grid unlock mode includes an end to the traffic congestion on the roadway or in the present lane of travel. For example, if the vehicle crosses a threshold speed, for example, 30 miles per hour, indicating a normal speed indicative of a lack of grid-lock, the grid unlock can return control of the vehicle to the driver. The threshold speed to terminate the grid unlock mode can but need not be the same as a threshold grid-lock speed required to activate the grid unlock mode. Such a return of control can be initiated by an alarm or alert to the driver indicating an impending return of control. Such an alert can an audible, indicated on a visual or head up display, can be indicated by a vibration in the seat or controls, or other similar methods to alert the driver known in the art. In a case of a driver failing to resume manual control of the vehicle, a number of reactions can be taken by the vehicle, for example, repeated and more urgent alerts, continued control of the vehicle for some period at a capped or maximum speed in the current lane of travel, and a controlled stop of the vehicle to the shoulder of the road. Similarly, if no target vehicle remains within a proximity of the vehicle or if a clear path to accelerate the vehicle opens, the grid unlock mode can be terminated and the vehicle can be returned to manual control.

Another example of a condition to terminate the grid unlock mode includes, in embodiments dependent upon GPS location, a persistent interruption of signals to the GPS device. As is known in the art, GPS devices require signals from satellites to operate. In embodiments dependent upon data from the GPS device, loss of the required signal can initiate termination of the grid unlock mode and return of control of the vehicle to manual control or an emergency stop including a controlled stop of the vehicle to the shoulder of the road.

Operation of the vehicle in a grid unlock mode requires certain safe travel conditions to exist. For example, if vehicle sensors such as anti-lock braking sensors determine that the current road is icy, operation of the grid unlock mode can be terminated. In another example, if a vehicle system experiences a maintenance failure, such as a radar device, a headlight, or occurrence of a tire failure, the grid unlock mode can be terminated. Depending upon the nature of the termination, the vehicle control can be returned to the driver or the vehicle can perform an emergency stop including a controlled stop of the vehicle to the shoulder of the road. Such safety factors can be reduced to a safe condition index and compared to a safe condition threshold in order to determine an appropriate action by the vehicle.

Control of the vehicle as compared to other vehicles in traffic can be accomplished according to a number of methods. Such methods can include a distance or range that can be fixed or modulated based upon the vehicle speed. In a related example, a distance envelope can be defined in certain directions or entirely around the vehicle based upon safe ranges in the directions. In another example, such a distance envelope can instead be based upon a “time to collision” estimate, calculating a relationship between the vehicle and objects around the vehicle and modulating the distance envelope based upon time to collision estimates. In one example, the calculated time to collision can be compared to a threshold time to collision, and a distance envelope for the vehicle can be indicated to be violated if the calculated time to collision is less than the threshold time to collision. A number of methods to evaluate a relationship of the vehicle to target vehicles or other objects in the proximity of the vehicle are known and envisioned, and the disclosure is not intended to be limited to the particular exemplary embodiments described herein.

Time to collision can be used as a metric to maintain distances or ranges between the vehicle and other vehicles or objects on the roadway. However, it will be appreciated that time to collision can provide an ability to monitor a likelihood of collision. Upon occurrence of a high likelihood of collision, measures can be taken by the grid unlock mode to avoid or lessen the effects of a collision. In one example, an urgent alert can be issued to the driver prompting a return to manual control. In another example, steering and speed control of the vehicle can be used to avoid the impending collision or suspension attributes can be altered to improve the reaction of the vehicle. In the event that a collision is deemed to be unavoidable, actions can be taken to minimize the effects of the collision, for example, maneuvering the vehicle to align the longitudinal axis of the vehicle to the collision or accelerating to lessen the impact to a rear-end collision.

As described above, the grid unlock mode is intended to be a hands off mode by the driver. In the event a selectable event occurs, the driver can be prompted to make a selection by methods such as button inputs, selections upon a touch screen display, or through voice commands.

As described above, V2V communication can be utilized as an input to the grid unlock mode. For example, if a group of vehicles within a grid-lock condition or a subset of a group of vehicles are similarly equipped and in communication, the communicating vehicles can move in a coordinated fashion, reducing uncertainty in the movement of the group, sharing sensor readings of non-communicating target vehicles or road geometry in the proximity of the group, and forming a formation of coordinated vehicles. A number of beneficial effects of V2V communication are envisioned, and the disclosure is not intended to be limited to the specific exemplary embodiments described herein.

As described above, V2I communications can be utilized as an input to the grid unlock mode. For example, construction, traffic delays, or other details can be communicated through V2I communication improving control of vehicles in grid unlock mode. Such information can encourage or control vehicles into a lane optimizing flow through a constricted portion of the roadway. In another embodiment, V2I communication can advise or instruct a vehicle according to a preset detour route, either for autonomous control or for notification to the driver in anticipation of returning manual control to the driver. In another embodiment, an infrastructure device can monitor traffic through a portion of roadway and transmit to the vehicle information regarding the grid-lock condition in advance. A number of beneficial effects of V2I communication are envisioned, and the disclosure is not intended to be limited to the specific exemplary embodiments described herein.

Operation of the grid unlock mode can assume that the vehicle intends to travel upon the current road indefinitely, waiting for the driver to intervene based upon a desired route of travel. In the alternative, the grid unlock mode can be combined with GPS and digital map devices to prompt the driver to intervene at a particular time. In another embodiment, the grid unlock mode can be configured to change lanes in advance of a roadway transition required by a planned route, thereby allowing the driver to intervene at the last minute to simply transition to the new roadway from the correct lane. In another embodiment, the vehicle can utilize a planned route, a digital map, and other inputs available to the vehicle to accomplish the required roadway transition while maintaining the grid unlock mode.

The disclosure has described certain preferred embodiments and modifications thereto. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. Method to operate a vehicle during a grid-lock traffic condition, the method comprising:
monitoring a vehicle speed;
tracking a target vehicle including monitoring a range to the target vehicle;
when the vehicle speed is less than a threshold grid-lock speed, monitoring activation of a grid unlock mode;
monitoring a location of the vehicle based upon data from a GPS device;
monitoring a distance envelope with respect to the vehicle; and
while the vehicle speed remains less than the threshold grid-lock speed, controlling operation of the vehicle, including vehicle acceleration, braking and steering, based upon the vehicle speed, the range to the target vehicle, the location of the vehicle, and the distance envelope.

2. The method of claim 1, further comprising monitoring operation of a traffic signal; and
wherein controlling operation of the vehicle is further based upon the monitored operation of the traffic signal.

3. The method of claim 1, wherein monitoring activation of a grid unlock mode comprises:
determining conditions for activation of the grid unlock mode to be met based upon the vehicle speed and the range to the target vehicle;
presenting a grid unlock mode option through a human machine interface device; and
monitoring selection of the grid unlock mode option through the human machine interface device.

4. The method of claim 1, further comprising terminating the controlling operation of the vehicle based upon no target vehicle remaining within the proximity of the vehicle.

5. The method of claim 1, further comprising terminating the controlling operation of the vehicle when no target vehicle is blocking acceleration of the vehicle.

6. The method of claim 1, further comprising:
comparing the range to the target vehicle to the distance envelope; and
generating a warning when the target vehicle is within the distance envelope.

7. The method of claim 1, wherein monitoring the distance envelope with respect to the vehicle comprises:
computing a time to collision estimate for the target vehicle;
comparing the time to collision estimate to a threshold time to collision; and
indicating the distance envelope to be violated based upon the comparing.

8. The method of claim 1, wherein monitoring the distance envelope with respect to the vehicle comprises:
monitoring a range distance in front of the vehicle.

9. The method of claim 8, wherein monitoring the distance envelope with respect to the vehicle further comprises:
monitoring range distances to the sides of the vehicle.

10. The method of claim 9, wherein monitoring the distance envelope with respect to the vehicle further comprises:
monitoring a range distance to the rear of the vehicle.

11. The method of claim 1, further comprising:
monitoring an input to a driver control of the vehicle; and
terminating the controlling operation of the vehicle based upon the monitored input indicating a driver override.

12. The method of claim 1, further comprising:
comparing the controlled operation of the vehicle to a safe condition threshold; and
generating a warning based upon the comparing.

13. The method of claim 12, further comprising:
navigating the vehicle to a road shoulder based upon the comparing.

14. The method of claim 1, further comprising monitoring a planned route for the vehicle; and
wherein controlling operation of the vehicle is further based upon the planned route for the vehicle.

15. The method of claim 1, wherein controlling steering comprising maintaining a present lane of travel.

16. The method of claim 1, further comprising determining a likelihood of collision based upon the vehicle speed, the range to the target vehicle, and the location of the vehicle; and
wherein controlling operation of the vehicle is further based upon the likelihood of collision.

17. The method of claim 1, further comprising monitoring voice commands; and
wherein the controlled operation of the vehicle is further based upon the monitored voice commands.

18. The method of claim 1, further comprising monitoring vehicle to vehicle communications; and
wherein the controlled operation of the vehicle is further based upon the monitored vehicle to vehicle communications.

19. The method of claim 1, further comprising monitoring vehicle to infrastructure communications; and
wherein the controlled operation of the vehicle is further based upon the monitored vehicle to infrastructure communications.

20. System for controlling a vehicle upon a roadway at slow speeds and in heavy traffic, the system comprising:
a sensing device tracking a target vehicle in proximity to the vehicle;
a global positioning device determining a position of the vehicle relative to a digital map; and
a control module:
monitoring conditions indicating a grid-lock condition;
monitoring selection of a grid unlock mode selector through a human machine interface device;
monitoring a speed of the vehicle;
monitoring data from the sensing device tracking the target vehicle;
monitoring data from the global positioning device;
determining a distance envelope for the vehicle based upon the speed of the vehicle, the data from the sensing device, and the data from the global positioning device; and
controlling vehicle acceleration, braking and steering based upon the distance envelope and the data from the global positioning device.
